(19) United States
(12) Patent Application Publication
(10) Pub. No.: US 2026/0308294 A1
(43) Pub. Date: Oct. 8, 2026

(54) DIALKYLATED METALLOCENE CATALYSTS FOR ETHYLENE POLYMERIZATION

(71) Applicant: Chevron Phillips Chemical Company LP, The Woodlands, TX (US)

(72) Inventors: Qing Yang, Bartlesville, OK (US); Ryan N. Rose, Bartlesville, OK (US); Justin O. Offutt, Bartlesville, OK (US); Eric D. Schwerdtfeger, Bartlesville, OK (US); Graham R. Lief, Bartlesville, OK (US); Mitchell D. Refvik, Bartlesville, OK (US); Sierra N. Hinkle, Bartlesville, OK (US)

(21) Appl. No.: 19/639,612

(22) Filed: Apr. 6, 2026

Related U.S. Application Data
(60) Provisional application No. 63/784,677, filed on Apr. 7, 2025.

(51) Int. Cl. C08F 210/16

(52) U.S. Cl. CPC C08F 210/16; C08F 2800/20

(57) ABSTRACT

Catalyst compositions can be prepared from a metallocene solution comprising from 10 to 70 wt. % of a dihydrocarbyl metallocene compound in a first aliphatic hydrocarbon solvent by adding an amount of a second aliphatic hydrocarbon solvent to the metallocene solution to form a dilute solution comprising from 0.1 to 10 wt. % of the dihydrocarbyl metallocene compound, followed by contacting, in any order, the dilute solution, an activator-support, and an organoaluminum compound to form the catalyst composition. Catalyst compositions comprising the metallocene solutions are also disclosed, as well as polymerization processes using the catalyst compositions to produce polymer products that are similar to the polymer products produced using non-alkylated metallocene compound analogs. Films produced from the polymer products demonstrate exceptionally low haze and improved strength characteristics.

### REFERENCE TO RELATED APPLICATION

This application claims the benefit of U.S. Provisional Patent Application No. 63/784,677, filed on Apr. 7, 2025, the disclosure of which is incorporated herein by reference in its entirety.

### TECHNICAL FIELD

The present disclosure relates generally to catalyst compositions comprising metallocene compounds, and to the use of the catalyst compositions in ethylene polymerization processes.

### BACKGROUND

Metallocenes used in the commercial production of polyethylene resin can have poor solubility in aliphatic solvents. The low solubility of metallocenes may be mitigated by including aromatic solvents though this approach raises environmental concerns in the polymerization processes and regulatory concerns for the resulting polymer products. Alternatively, the solubility of metallocenes may be improved by the addition of organoaluminum compounds in a catalyst composition. Catalyst solutions, however, have a shelf life and are not stable in storage. Metallocene compounds with increased solubility in aliphatic solvents would be beneficial for use in catalyst compositions for ethylene polymerization, particularly if similar or better polymer products could be produced with similar or better catalyst activity. Accordingly, it is to these ends that the present invention is generally directed.

### SUMMARY

This summary is provided to introduce a selection of concepts in a simplified form that are further described herein. This summary is not intended to identify required or essential features of the claimed subject matter. Nor is this summary intended to be used to limit the scope of the claimed subject matter.

Methods for preparing catalyst compositions, methods for using the catalyst compositions to polymerize olefins, polymer resins produced using such catalyst compositions, and articles produced using these polymer resins are disclosed herein. In one aspect, a process to produce a catalyst composition is provided, and in this aspect, the process can comprise (i) providing a metallocene solution comprising from 10 to 70 wt. % of a dihydrocarbyl metallocene compound in a first aliphatic hydrocarbon solvent, (ii) adding an amount of a second aliphatic hydrocarbon solvent to the metallocene solution to form a dilute solution comprising from 0.1 to 10 wt. % of the dihydrocarbyl metallocene compound, and (iii) contacting, in any order, the dilute solution, an activator-support, and an organoaluminum compound to form the catalyst composition.

Also disclosed herein are catalyst compositions comprising an organoaluminum compound, an activator, and a metallocene solution. In certain aspects, the metallocene solution can comprise an aliphatic hydrocarbon solvent and a metallocene compound having Formula (I):

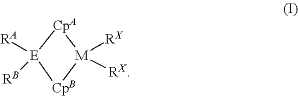

The metallocene solution can comprise an amount of the metallocene compound in a range from 10 to 70 wt. %. In certain aspects, M can be Zr, Ti, or Hf, Cp^{A} and Cp^{B} independently can be a substituted or unsubstituted cyclopentadienyl group, a substituted or unsubstituted indenyl group, or a substituted or unsubstituted fluorenyl group, and E can be C, Si, or Ge or B. Each RX can be a C₁ to C₁₈ hydrocarbyl group, and each R^{A} and R^{B} independently can be H, a C₁ to C₃₆ hydrocarbyl group, a C₁ to C₃₆ hydrocarboxy group, or a C₁ to C₃₆ hydrocarbylsilyl group.

In further aspects, the metallocene solution of the disclosed methods and catalyst compositions can comprise an aliphatic hydrocarbon solvent and a metallocene compound having Formula (IV):

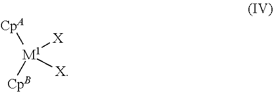

The metallocene solution can comprise an amount of the metallocene compound of Formula (IV) in a range from 10 to 70 wt. %. In certain aspects, M¹ in formula (IV) can be Zr or Hf, Cp^{A} and Cp^{B} independently can be a substituted or unsubstituted cyclopentadienyl group or a substituted or unsubstituted indenyl group, and each X independently can be a C₁ to C₁₈ hydrocarbyl group.

Catalyst compositions as disclosed herein may be employed within polymerization processes that can comprise contacting the catalyst composition with an olefin monomer and an optional olefin comonomer in a polymerization reactor system under polymerization conditions to produce an olefin polymer. Olefin polymers and articles produced therefrom are also contemplated herein, and can include films having exceptional haze and strength properties. In certain aspects, a film can have a haze from 2 to 5%, a MD Elmendorf tear strength from 150 to 250 g/mil (5.91 to 9.84 g/μm), a TD Elmendorf tear strength from 225 to 550 g/mil (8.86 to 21.65 g/μm), and a ratio of TD Elmendorf tear strength to MD Elmendorf tear strength (TD:MD) from 1:1 to 5:1.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to these figures in combination with the detailed description.

FIG. 1 presents a chart comparing the ethylene consumption during polymerization reactions using MET-1, MET-2, or MET-3 with TIBA.

FIG. 2 presents a chart comparing the ethylene consumption during polymerization reactions using MET-1 or MET-2, and TNBA.

FIG. 3 presents a chart comparing the ethylene consumption during polymerization reactions using MET-1 or MET-2 and TEA.

FIG. 4 presents a chart comparing the ethylene consumption during polymerization reactions using MET-1 or MET-2 and TMA.

FIG. 5 presents a plot of the molecular weight distributions of the polymers of Comparative Examples C34 and C42-C44.

FIG. 6 presents a plot of the molecular weight distributions of the polymers of Examples 50 and 58-60.

While the inventions disclosed herein are susceptible to various modifications and alternative forms, only a few specific aspects have been shown by way of example in the drawings and described in detail below. The figures and detailed description of specific aspects are not intended to limit the breadth or scope of the inventive concepts or the appended claims in any manner. Rather, the figures and detailed description are provided to illustrate the inventive concepts to a person of ordinary skill in the art and to enable such person to make and use the inventive concepts.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the compounds, compositions, processes, or methods described herein are contemplated with or without explicit description of the particular combination. Additionally, unless explicitly recited otherwise, any aspect or feature disclosed herein can be combined to describe inventive compounds, compositions, processes, or methods consistent with the present disclosure.

In this disclosure, while compositions and processes/methods are described in terms of “comprising” various materials or components and steps, the compositions and processes/methods also can “consist essentially of” or “consist of” the various materials or components and steps, unless stated otherwise. For example, a metallocene solution consistent with aspects of the present invention can comprise; alternatively, can consist essentially of, or alternatively, can consist of; a metallocene compound and an aliphatic hydrocarbon solvent. The terms “a,” “an,” and “the” are intended to include plural alternatives, e.g., at least one, unless otherwise specified. For instance, the disclosure of “an organoaluminum compound” is meant to encompass one, or mixtures or combinations of two or more, organoaluminum compound(s), unless otherwise specified.

For any generic or specific compound or group disclosed herein, any name or structure presented is intended to encompass all conformational isomers, regioisomers, stereoisomers, and mixtures thereof that can arise from a particular set of substituents, unless otherwise specified. The name or structure also encompasses all enantiomers, diastereomers, and other optical isomers (if there are any), whether in enantiomeric or racemic forms, as well as mixtures of stereoisomers, as would be recognized by a skilled artisan, unless otherwise specified. For example, a general reference to hexene (or hexenes) includes all linear or branched, acyclic or cyclic, hydrocarbon compounds having six carbon atoms and 1 carbon-carbon double bond; a general reference to pentane includes n-pentane, 2-methyl-butane, and 2,2-dimethylpropane; and a general reference to a butyl group includes an n-butyl group, a sec-butyl group, an iso-butyl group, and a t-butyl group.

The terms “contacting” and “combining” are used herein to describe compositions and processes/methods in which the materials are contacted or combined together in any order, in any manner, and for any length of time, unless otherwise specified. For example, the materials can be blended, mixed, slurried, dissolved, reacted, treated, impregnated, compounded, or otherwise contacted or combined in some other manner or by any suitable method or technique.

The term “hydrocarbon” whenever used in this specification and claims refers to a compound containing only carbon and hydrogen, whether saturated or unsaturated. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The terms “alkylated” and “dialkylated” are used herein to describe the presence of hydrocarbyl substituents directly bound to the transition metal of a metallocene compound, particularly in comparison to “non-alkylated” structures where the hydrocarbyl substituents are not present (e.g., chloride substituents). In this manner, “alkylated” or “dialkylated” do not necessarily require an alkyl substituent, and can comprise instead any suitable hydrocarbyl substituent as defined herein, such as a phenyl or benzyl substituent.

The term “olefin” includes aliphatic and aromatic, cyclic and acyclic, and/or linear and branched compounds having at least one carbon-carbon double bond that is not part of an aromatic ring or ring system, unless specifically stated otherwise. Olefins having only one, only two, only three, etc., carbon-carbon double bonds can be identified by use of the term “mono,” “di,” “tri,” etc., within the name of the olefin. Olefins can be further identified by the position of the carbon-carbon double bond(s). The term “alpha olefin” as used herein refers to any olefin that has a double bond between the first and second carbon atom of a contiguous chain of carbon atoms.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. Unless otherwise specified, “substituted” is intended to be non-limiting and include inorganic substituents or organic substituents as understood by one of ordinary skill in the art.

The term “polymer” is used herein generically to include olefin homopolymers, copolymers, terpolymers, and the like, as well as alloys and blends thereof. The term “polymer” also includes impact, block, graft, random, and alternating copolymers. A copolymer is derived from an olefin monomer and one olefin comonomer, while a terpolymer is derived from an olefin monomer and two olefin comonomers. Accordingly, “polymer” encompasses copolymers and terpolymers derived from any olefin monomer and comonomer(s) disclosed herein. Similarly, the scope of the term “polymerization” includes homopolymerization, copolymerization, and terpolymerization. Therefore, an ethylene polymer includes ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an olefin copolymer, such as an ethylene copolymer, can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, unless stated otherwise, and such configurations can include isotactic, syndiotactic, and random symmetries. Moreover, unless stated otherwise, the term “polymer” also is meant to include all molecular weight polymers.

The “activator-support” of this disclosure can be a chemically-treated solid oxide. The terms “support” and “activator-support” are not used to imply these components are inert, and such components should not be construed as an inert component of the catalyst composition. The term “activator,” as used herein, refers generally to a substance that is capable of converting a metallocene component into a catalyst that can polymerize olefins, or converting a contact product of a metallocene component and a component that provides an activatable ligand (e.g., an alkyl, a hydride) to the metallocene, when the metallocene compound does not already comprise such a ligand, into a catalyst that can polymerize olefins. This term is used regardless of the actual activating mechanism. Illustrative activators include activator-supports, aluminoxanes, organoboron or organoborate compounds, ionizing ionic compounds, and the like. Aluminoxanes, organoboron or organoborate compounds, and ionizing ionic compounds generally are referred to as activators if used in a catalyst composition in which an activator-support is not present. If the catalyst composition contains an activator-support, then the aluminoxane, organoboron or organoborate, and ionizing ionic materials are typically referred to as co-catalysts.

The term “metallocene” as used herein describes compounds comprising at least one η³ to η⁵-cycloalkadienyl-type moiety, wherein η³ to η⁵-cycloalkadienyl moieties include cyclopentadienyl ligands, indenyl ligands, fluorenyl ligands, and the like, including partially saturated or substituted derivatives or analogs of any of these. Possible substituents on these ligands can include H, therefore encompassed herein are ligands such as tetrahydroindenyl, tetrahydrofluorenyl, octahydrofluorenyl, partially saturated indenyl, partially saturated fluorenyl, substituted partially saturated indenyl, substituted partially saturated fluorenyl, and the like. In some contexts, the metallocene is referred to simply as the “catalyst,” in much the same way the term “co-catalyst” is used herein to refer to, for example, an organoaluminum compound.

The terms “catalyst composition,” “catalyst mixture,” “catalyst system,” and the like, do not depend upon the actual product or composition resulting from the contact or reaction of the initial components of the disclosed or claimed catalyst composition (or catalyst mixture or catalyst system), the nature of the activated catalyst composition, or the fate of the activator, the organoaluminum compound, and the metallocene compound after combining these components. Therefore, the terms “catalyst composition,” “catalyst mixture,” “catalyst system,” and the like, encompass the initial starting components of the composition, as well as whatever product(s) may result from contacting these initial starting components, and this is inclusive of both heterogenous and homogenous catalyst systems or compositions. The terms “catalyst composition,” “catalyst mixture,” “catalyst system,” and the like, may be used interchangeably throughout this disclosure.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the molar ratio of Al:transition metal in the catalyst composition can be in various ranges. By a disclosure that the molar ratio can be in a range from 10:1 to 5,000:1, the intent is to recite that the molar ratio can be any molar ratio within the range and, for example, can include any range or combination of ranges from 10:1 to 5,000:1, such as from 50:1 to 3,000:1, from 75:1 to 2,000:1, from 100:1 to 2,000:1, or from 100:1 to 1,000:1, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION

Disclosed herein are catalyst compositions containing metallocene solutions and ethylene polymerization processes utilizing the catalyst compositions to produce olefin polymers useful in products such as blown and cast films.

### Catalyst Compositions

In accordance with aspects of the present invention, catalyst compositions are disclosed herein comprising an organoaluminum compound, an activator, and a metallocene solution. The metallocene solution can comprise a metallocene compound and an aliphatic hydrocarbon solvent. In certain aspects, the metallocene compound can be a compound having Formula (I):

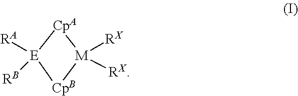

Within Formula (I), M, Cp^{A}, Cp^{B}, E, R^{A}, R^{B}, and each R^{X} are independent elements of the bridged metallocene compound. Unless otherwise specified, Formula (I) above, any other structural formulas disclosed herein, and any metallocene complex, compound, or species disclosed herein are not designed to show stereochemistry or isomeric positioning of the different moieties (e.g., these formulas are not intended to display cis or trans isomers, or R or S diastereoisomers), although such compounds are contemplated and encompassed by these formulas and/or structures.

In accordance with aspects of this invention, the metal in Formula (I), M, can be Zr, Ti, or Hf. Thus, M can be Zr in one aspect, M can be Ti in another aspect, and M can be Hf in yet another aspect.

In Formula (I), Cp^{A} can be a cyclopentadienyl, indenyl, or fluorenyl group, either substituted or unsubstituted. If present, each substituent on Cp^{A} independently can be H, a halide, a C₁ to C₃₆ hydrocarbyl group, a C₁ to C₃₆ halogenated hydrocarbyl group, a C₁ to C₃₆ hydrocarboxy group, or a C₁ to C₃₆ hydrocarbylsilyl group. Each substituent on Cp^{A} can be either the same or a different substituent group. Moreover, each substituent can be at any position on the respective cyclopentadienyl, indenyl, or fluorenyl ring structure that conforms with the rules of chemical valence. In an aspect, the number of substituents on Cp^{A} and/or the positions of each substituent on Cp^{A} are independent of each other. For instance, two or more substituents on Cp^{A} can be different, or alternatively, each substituent on Cp^{A} can be the same. In these and other aspects, each substituent can be at any position on the respective cyclopentadienyl, indenyl, or fluorenyl ring structure. Therefore, Cp^{A} can have one substituent, or two substituents, or three substituents, or four substituents, or five substituents, and so forth. In certain aspects, Cp^{A} can have a C₁-C₁₂ alkyl, C₂-C₁₂ alkenyl, C₆-C₁₀ aryl, or C₇-C₁₂ aralkyl substituent (e.g., benzyl).

In Formula (I), Cp^{B} can be a substituted or unsubstituted cyclopentadienyl, indenyl, or fluorenyl group. In one aspect, Cp^{A} and Cp^{B} independently can be an unsubstituted cyclopentadienyl or indenyl group. Alternatively, Cp^{A} and Cp^{B} independently can be a substituted indenyl or cyclopentadienyl group, for example, having up to 5 substituents. Cp^{A} and Cp^{B} can be the same or different. In certain aspects, Cp^{A} can be a substituted or unsubstituted fluorenyl group and Cp^{B} can be an unsubstituted cyclopentadienyl group.

If present, each substituent on Cp^{B} independently can be H, a halide, a C₁ to C₃₆ hydrocarbyl group, a C₁ to C₃₆ halogenated hydrocarbyl group, a C₁ to C₃₆ hydrocarboxy group, or a C₁ to C₃₆ hydrocarbylsilyl group. As above for Cp^{A}, each substituent on Cp^{B} can be either the same or a different substituent group. Moreover, each substituent can be at any position on the respective cyclopentadienyl, indenyl, or fluorenyl ring structure that conforms with the rules of chemical valence. In an aspect, the number of substituents on Cp^{B} and/or the positions of each substituent on Cp^{B} are independent of each other. For instance, two or more substituents on Cp^{B} can be different, or alternatively, all substituents on Cp^{B} can be the same. In another aspect, one or more of the substituents on Cp^{A} can be different from the one or more of the substituents on Cp^{B}, or alternatively, all substituents on both Cp^{A} and/or on Cp^{B} can be the same. In these and other aspects, each substituent can be at any position on the respective cyclopentadienyl, indenyl, or fluorenyl ring structure. If substituted, Cp^{B} independently can have one substituent, or two substituents, or three substituents, or four substituents, or five substituents and so forth. As above for Cp^{A}, in certain aspects, Cp^{B} can have a C₁-C₁₂ alkyl, C₂-C₁₂ alkenyl, C₆-C₁₀ aryl, or C₇-C₁₂ aralkyl substituent (e.g., benzyl).

The bridging group in Formula (I) can be a bridging group having the formula ER^{A}R^{B}, wherein E can be C, Si, or Ge or B, and R^{A} and R^{B} independently can be H, a C₁ to C₃₆ hydrocarbyl group, a C₁ to C₃₆ hydrocarboxy group, or a C₁ to C₃₆ hydrocarbylsilyl group. In some aspects of this invention, E can be C, and R^{A} and R^{B} independently can be H or a C₁ to C₁₈ hydrocarbyl group; alternatively, R^{A} and R^{B} independently can be a C₁ to C₈ hydrocarbyl group; alternatively, R^{A} and R^{B} independently can be a phenyl group, a C₁ to C₈ alkyl group, or a C₃ to C₈ alkenyl group; or alternatively, R^{A} and R^{B} independently can be a methyl group, an ethyl group, a propyl group, a butyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a cyclohexylphenyl group, a naphthyl group, a tolyl group, or a benzyl group. In these and other aspects, R^{A} and R^{B} can be either the same or different. For instance, in certain aspects, R^{A} and R^{B} each can be phenyl. In other aspects, R^{A} can be a methyl group and R^{B} can be a butenyl group.

Alternatively, R^{A} and R^{B} can be joined to form a bicyclic bridging group connected to a substituent of Cp^{A} or Cp^{B}, often a C₇ to C₁₈ bicyclic bridging group, a C₇ to C₁₂ bicyclic bridging group, or a C₇ to C₁₀ bicyclic bridging group. In one aspect of this invention, for instance, ER^{A}R^{B} can be a saturated hydrocarbon group, while in another aspect, ER^{A}R^{B} can be an unsaturated hydrocarbon group, and in yet another aspect, ER^{A}R^{B} can be an aromatic hydrocarbon group.

Thus, in view of the description above, in certain aspects, catalyst compositions can comprise a metallocene compound having Formula (II):

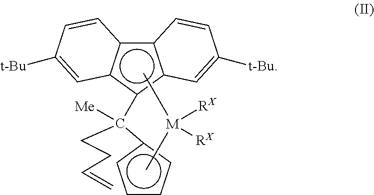

In Formulas (I) and (II), each R^{X} can be a C₁ to C₁₈ hydrocarbyl group; or alternatively, a C₁ to C₈ hydrocarbyl group. Hydrocarbyl is used herein to specify a hydrocarbon radical group and includes, for instance, aryl, alkyl, cycloalkyl, alkenyl, cycloalkenyl, cycloalkadienyl, alkynyl, aralkyl, aralkenyl, and aralkynyl groups. In one aspect, each R^{X} can be any hydrocarbyl having from 1 to 18 carbon atoms, or from 1 to 8 carbon atoms, or an alkyl having from 1 to 10 carbon atoms. For example, each R^{X} can be methyl, ethyl, propyl, n-butyl, sec-butyl, isobutyl, or hexyl, and the like, in certain aspects of the present invention. In other aspects, each R^{X} can be a methyl group, an ethyl group, a propyl group, a butyl group, a pentyl group, a hexyl group, a phenyl group, or a benzyl group. In certain aspects, each R^{X} can be the same, thus, each R^{X} can be a methyl group; alternatively, each R^{X} can be a phenyl group; or alternatively, each R^{X} can be a benzyl group. Specific and non-limiting examples of bridged metallocene compounds of formula (I) and/or formula (II) include the following (Me=methyl, Ph=phenyl; t-Bu=tert-butyl):

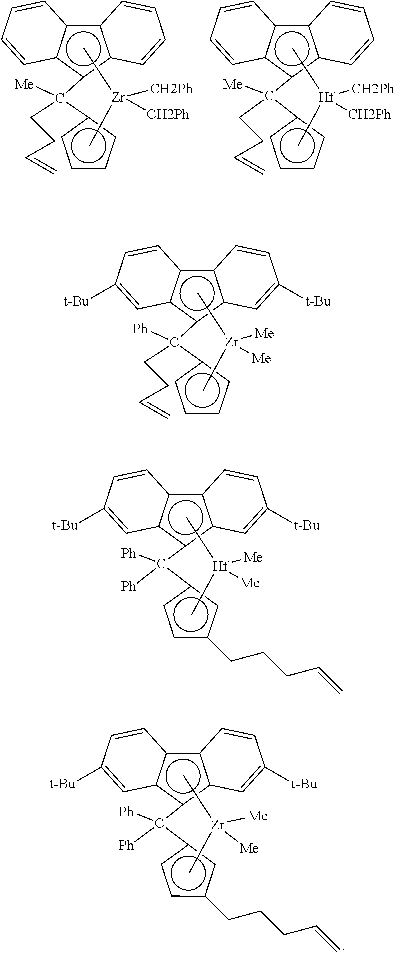

As will be understood by those of skill in the art, metallocene compounds as described above may be prepared through nucleophilic substitution at X¹ and X² of compounds having Formula (III):

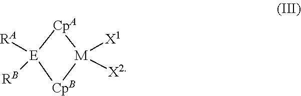

X¹ and X² independently can be a monoanionic ligand subject to substitution using Grignard reagents (e.g., methylmagnesium halides, benzylmagnesium halides) or alkyllithium reagents (e.g., methyllithium, phenyllithium). In certain aspects, X¹ and X² can be C₁.

In various aspects of the present invention, the metallocene compound of the disclosed processes and catalyst compositions can comprise an unbridged metallocene compound. In one aspect, the dihydrocarbyl metallocene compound can be an unbridged zirconium or hafnium based metallocene compound containing two cyclopentadienyl groups, two indenyl groups, or a cyclopentadienyl and an indenyl group, while in another aspect, the dihydrocarbyl metallocene compound can be an unbridged zirconium based metallocene compound containing a cyclopentadienyl group and an indenyl group. In yet another aspect, the dihydrocarbyl metallocene compound can have Formula (IV):

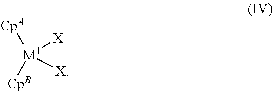

Within Formula (IV), M¹, Cp^{A}, Cp^{B}, and each X are independent elements of the unbridged metallocene compound. Unless otherwise specified, Formula (IV) above, any other structural formulas disclosed herein, and any metallocene complex, compound, or species disclosed herein are not designed to show stereochemistry or isomeric positioning of the different moieties (e.g., these formulas are not intended to display cis or trans isomers, or R or S diastereoisomers), although such compounds are contemplated and encompassed by these formulas and/or structures.

In accordance with aspects of this invention, the metal in formula (IV), M¹, can be Zr or Hf. In one aspect, for instance, M¹ can be Zr, while in another aspect, M¹ can be Hf. Each X in formula (IV) can be a C₁ to C₁₈ hydrocarbyl group; or alternatively, a C₁ to C₈ hydrocarbyl group. For example, each X independently, can be methyl, ethyl, propyl, n-butyl, sec-butyl, isobutyl, or hexyl, and the like, in certain aspects of the present invention. In other aspects, each X independently can be a methyl group, an ethyl group, a propyl group, a butyl group, a pentyl group, a hexyl group, a phenyl group, or a benzyl group. In certain aspects, each X can be the same, thus, each X can be a methyl group; alternatively, each X can be a phenyl group; or alternatively, each X can be a benzyl group.

Cp^{A} and Cp^{B} independently can be a substituted or unsubstituted cyclopentadienyl group or a substituted or unsubstituted indenyl group. In one aspect, Cp^{A} and Cp^{B} independently can be an unsubstituted cyclopentadienyl or an unsubstituted indenyl group. Alternatively, Cp^{A} and Cp^{B} independently can be a substituted indenyl or a substituted cyclopentadienyl group, for example, having up to 5 substituents. Suitable substituents for Cp^{A} and Cp^{B} in formula (IV) are the same as those described above for Cp^{A} and Cp^{B} in formula (I). Thus, when substituted, Cp^{A} and/or Cp^{B} can have one or more substituents independently selected from a C₁-C₁₂ alkyl, C₂-C₁₂ alkenyl, C₆-C₁₀ aryl, or C₇-C₁₂ aralkyl (e.g., benzyl).

Specific and non-limiting examples of unbridged dihydrocarbyl metallocene compounds that can be utilized in the metallocene solutions, catalyst compositions, and polymerization processes include the following (Me=methyl, Ph=phenyl):

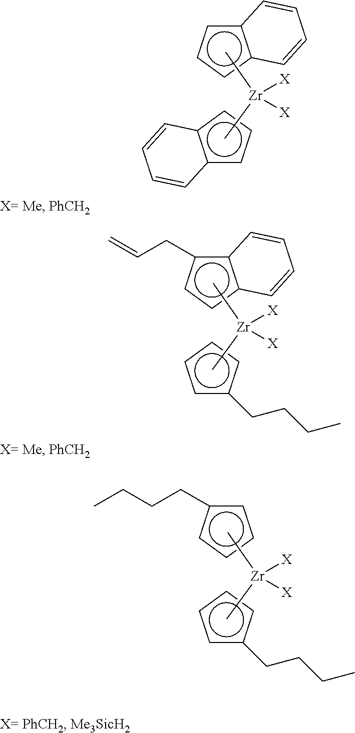

As stated above, catalyst compositions disclosed herein can comprise a metallocene solution comprising (or consisting of, or consisting essentially of) any metallocene compound described herein and an aliphatic hydrocarbon solvent. In certain aspects, the aliphatic hydrocarbon solvent can be a linear aliphatic hydrocarbon (e.g., paraffin), a branched aliphatic hydrocarbon (e.g., isoparaffin), or a cyclic aliphatic hydrocarbon, as well as combinations thereof. Thus, the hydrocarbon solvent can comprise a linear alkane, a branched alkane, a cyclic alkane, or a combination thereof. In certain aspects, the aliphatic hydrocarbon solvent can be a C₃ to C₁₆ alkane; alternatively a C₄ to C₈ alkane. Illustrative examples of saturated aliphatic hydrocarbons that can be utilized as the solvent, either singly or in combination, include propane, butane (e.g., n-butane or isobutane), pentane (e.g., n-pentane, neopentane, cyclopentane, or isopentane), hexane (e.g., n-hexane, 2-methylpentane, 3-methylpentane, 2,2-dimethylbutane, or 2,3-dimethylbutane), heptane (e.g., n-heptane, 2-methylhexane, 3-methylhexane, 2,2-dimethylpentane, 2,3-dimethylpentane, 2,4-dimethylpentane, 3,3-dimethylpentane, 3-ethylpentane, or 2,2,3-trimethylbutane), octane (e.g., n-octane, 2-methylheptane, 3-methylheptane, 4-methylheptane, 2,2-dimethylhexane, 2,3-dimethylhexane, 2,4-dimethylhexane, 2,5-dimethylhexane, 3,3-dimethylhexane, 3,4-dimethylhexane, 3-ethylhexane, 2,2,3-trimethylpentane, 2,2,4-trimethylpentane, 2,3,3-trimethylpentane, 2,3,4-trimethylpentane, 3-ethyl-2-methylpentane, 3-ethyl-3-methylpentane, 2,2,3,3-tetramethylbutane), cyclohexane, methyl cyclohexane, and the like, as well combinations thereof. In a particular aspect of this disclosure, the hydrocarbon solvent can comprise (or consist essentially of, or consist of) hexane(s). In another aspect of this disclosure, the hydrocarbon solvent can comprise (or consist essentially of, or consist of) heptane(s). In a still further aspect of this disclosure, the hydrocarbon solvent can comprise (or consist essentially of, or consist of) isobutane.

The amount of the metallocene compound and the amount of the aliphatic hydrocarbon solvent in the metallocene solution are not particularly limited. Dialkylated metallocene compounds of Formula (I) and Formula (II) as disclosed herein unexpectedly demonstrate an increased solubility in aliphatic solvents relative to a non-alkylated precursor of Formula (III), wherein each of M, Cp^{A}, Cp^{B}, E, R^{A}, R^{B} are the same as that of the metallocene compound of Formula (I) and Formula (II), and X¹ and X² each are a halide, such as C₁. In certain aspects, the solubility of the metallocene compound of Formula (I) and Formula (II) can be at least 100%, at least 300%, at least 500%, at least 1,000%, or at least 2,000% greater than; or alternatively, in a range from 100% to 10,000% or from 500% to 5,000% greater than, that of the solubility of an otherwise identical metallocene compound of Formula (III) in which both X¹ and X² are C₁.

Thus, the metallocene solutions (and catalyst compositions) of the present invention may contain relatively high amounts of the metallocene compound relative to the aliphatic hydrocarbon solvent. For example, a solubility of the metallocene compound in the aliphatic hydrocarbon solvent at 25° C. can be at least 0.1 wt. %, at least 0.2 wt. %, at least 0.3 wt. %, at least 0.5 wt. %, at least 0.8 wt. %, at least 1 wt. %, at least 1.5 wt. %, at least 2 wt. %, at least 2.5 wt. %, at least 3 wt. %, at least 3.5 wt. %, at least 4 wt. %, at least 5 wt. %, at least 6 wt. %, at least 7 wt. %, or at least 8 wt. %. Additionally or alternatively, the solubility of the metallocene compound in the aliphatic hydrocarbon solvent at 25° C. can be in a range from 0.1 wt. % to 10 wt. %, from 0.2 wt. % to 8 wt. %, from 0.5 wt. % to 5 wt. %, or any range bounded by any two values recited above (e.g., from 0.5 wt. % to 10 wt. %, from 2 wt. % to 8 wt. %).

Due to the increased solubility, the amount of the metallocene compound present in the metallocene solution can be at least 0.1 wt. %, at least 0.2 wt. %, at least 0.35 wt. %, at least 0.5 wt. %, at least 1 wt. %, at least 2 wt. %, or at least 3 wt. %. In other aspects, the amount of metallocene compound present in the metallocene solution can be up to 0.5 wt. %, up to 1 wt. %, up to 3 wt. %, or up to 5 wt. %; alternatively, in a range from 0.1 wt. % to 5 wt. %, from 0.5 wt. % to 5 wt. %, from 1 wt. % to 4 wt. %, or from 2 wt. % to 4 wt. %. The amount of the aliphatic hydrocarbon solvent can be at least 85 wt. %, at least 90 wt. %, at least 95 wt. %, at least 96 wt. %, at least 97 wt. %, at least 98 wt. %, at least 99 wt. %, or at least 99.5 wt. % of the metallocene solution; or alternatively, in a range from 90 wt. % to 99.9 wt. %, from 92 wt. % to 99.9 wt. %, or from 95 wt. % to 99.5 wt. %.

Advantageously, due to the increased solubility in aliphatic solvents, the use of aromatic solvents in the formation, storage, and transport of metallocene-based catalyst compositions is typically not required. Aromatic solvents are commonly used to improve the solubility of metallocene compounds in storage, transport, and use. However, aromatic solvents like toluene can be difficult to remove and may lead to environmental and regulatory concerns for the end-use polymer products. In certain aspects, the metallocene solution can exclude aromatic compounds such as toluene altogether. In other aspects, the metallocene solution can exclude olefins such as 1-hexene. Thus, in certain aspects, the metallocene solutions described above may consist of, or consist essentially of, the aliphatic hydrocarbon solvent and the metallocene compound at any of the combination of relative amounts for the respective components as described above. In certain aspects, the metallocene solution can comprise (or consist essentially of, or consist of) from 95 wt. % to 99.9 wt. % of the aliphatic hydrocarbon solvent and from 0.1 wt. % to 5 wt. % of the metallocene compound. Alternatively, the metallocene solution can comprise (or consist essentially of, or consist of) from 96 wt. % to 99 wt. % of the aliphatic hydrocarbon solvent and from 1 wt. % to 4 wt. % of the metallocene compound.

Additionally or alternatively, metallocene solutions disclosed herein can further comprise additional components, for instance to improve solubility or stability of the metallocene compounds. In certain aspects, the metallocene solution can further comprise 1-hexene at any suitable amount.

Catalyst s disclosed herein can comprise an organoaluminum compound (e.g., an alkylaluminum compound). For instance, the catalyst compositions can comprise a trialkylaluminum, an alkylaluminum halide, an alkylaluminum alkoxide, or any combination thereof. In some aspects, the alkylaluminum compound can be a trialkylaluminum, an alkylaluminum halide, or any combination thereof. In other aspects, the alkylaluminum compound can be a trialkylaluminum; alternatively, an alkylaluminum halide; or alternatively, an alkylaluminum alkoxide.

Each alkyl group of an alkylaluminum compound independently can be a C₁ to C₂₀ alkyl group; alternatively, a C₁ to C₁₀ alkyl group; or alternatively, a C₁ to C₆ alkyl group. In an aspect, each alkyl group of an alkylaluminum compound independently can be a methyl group, an ethyl group, a propyl group, a butyl group, a pentyl group, a hexyl group, a heptyl group, or an octyl group; or alternatively, a methyl group, an ethyl group, a butyl group, a hexyl group, or an octyl group. In some aspects, each alkyl group of an alkylaluminum compound can be a methyl group, an ethyl group, an n-propyl group, an n-butyl group, an iso-butyl group, an n-hexyl group, or an n-octyl group; alternatively, a methyl group, an ethyl group, an n-butyl group, or an iso-butyl group; alternatively, a methyl group; alternatively, an ethyl group; alternatively, an n-propyl group; alternatively, an n-butyl group; alternatively, an iso-butyl group; alternatively, an n-hexyl group; or alternatively, an n-octyl group.

While not being limited thereto, representative organoaluminum compounds (e.g., alkylaluminum compounds) can include trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and the like, as well as any combination thereof.

The amount of the organoaluminum compound is not limited to any particular amount, and generally can be any suitable amount to promote the olefin polymerization reaction. In certain aspects, the amount of the organoaluminum compound in the catalyst composition can be relative to the amount of transition metal of the metallocene compound in the catalyst composition. Molar ratios of Al: transition metal in the catalyst compositions disclosed herein can range from 10:1 to 5,000:1, such as from 50:1 to 3,000:1, from 75:1 to 2,000:1, from 100:1 to 2,000:1, or from 100:1 to 1,000:1, and the like. If, for example, more than metallocene and/or more than one organoaluminum are employed, these ratios are based on the total moles of respective transition metals and organoaluminums.

Catalyst compositions disclosed herein can comprise an activator. The activator can be an activator-support, an aluminoxane compound, an organoboron or organoborate compound, an ionizing ionic compound, and the like, or any combination thereof. Examples of such activators are disclosed in, for instance, U.S. Pat. Nos. 3,242,099, 4,794,096, 4,808,561, 5,576,259, 5,807,938, 5,919,983, and 8,114,946. In an aspect, the catalyst composition can contain one or more than one activator. In another aspect, the catalyst composition can comprise an aluminoxane compound. The aluminoxane compound can comprise, consist essentially of, or consist of, methylaluminoxane (MAO), ethylaluminoxane, modified methylaluminoxane (MMAO), n-propylaluminoxane, iso-propyl-aluminoxane, n-butylaluminoxane, sec-butylaluminoxane, iso-butylaluminoxane, t-butylaluminoxane, 1-pentylaluminoxane, 2-pentylaluminoxane, 3-pentyl-aluminoxane, iso-pentyl-aluminoxane, neopentylaluminoxane, or mixtures thereof. In yet another aspect, the catalyst composition can comprise an organoboron or organoborate compound. In still another aspect, the catalyst composition can comprise an ionizing ionic compound. Alternatively, the catalyst composition may be substantially free of aluminoxane compounds, organoboron and organoborate compounds, ionizing ionic compounds, or combinations thereof.

In other aspects, the activator can be an activator-support, for example, an activator-support comprising a solid oxide treated with an electron-withdrawing anion. For instance, the activator-support can comprise fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided-chlorided silica-coated alumina, fluorided silica-coated alumina, sulfated silica-coated alumina, or phosphated silica-coated alumina, and the like, as well as any combination thereof. In some aspects, the activator-support can comprise a fluorided solid oxide and/or a sulfated solid oxide; or alternatively, fluorided silica-coated alumina, sulfated silica-coated alumina, or a combination thereof. Examples of such materials are disclosed in, for instance, U.S. Pat. Nos. 7,294,599, 7,601,665, 7,884,163, 8,309,485, 8,623,973, and 9,023,959.

Generally, the weight ratio of the metallocene compound to the activator-support in the catalyst composition is not particularly limited. Nonetheless, this weight ratio often falls within a range from 1:1 to 1:100,000, such as from 1:10 to 1:10,000, from 1:1 to 1:1000, from 1:10 to 1:200, or from 1:10 to 1:50. Likewise, the weight ratio of the activator-support to the organoaluminum compound in the catalyst composition is not particularly limited. Illustrative and non-limiting ranges of this weight ratio include from 100:1 to 1:100, from 10:1 to 1:10, from 5:1 to 1:5, or from 20:1 to 1:1.

Surprisingly, catalyst compositions of the present invention can have a metallocene activity under polymerization conditions that exceeds that of otherwise identical catalyst compositions comprising a metallocene compound of Formula (III). Catalyst compositions of the present invention generally have a catalyst activity greater than 100,000 grams, greater than 150,000 grams, greater than 200,000 grams, greater than 250,000 grams, greater than 300,000 grams, greater than 350,000 grams, greater than 400,000 grams, greater than 500,000 grams, etc., of ethylene polymer (homopolymer or copolymer, as the context requires) per gram of the metallocene compound per hour (abbreviated g/g/hr). In another aspect, the catalyst activity may range from 100,000 to 1,000,000, from 250,000 to 750,000, or from 350,000 to 650,000 g/g/hr. These activities are measured under slurry polymerization conditions, with triisobutylaluminum as the organoaluminum compound, using isobutane as the diluent, at a polymerization temperature of 75 to 100° C. (e.g., 80° C.) and a reactor pressure of 200 to 500 psig (2.07 MPa to 3.45 MPa) (e.g., 270 (1.86 MPa) or 320 psig (2.21 MPa)).

### Catalyst Preparation Processes

Processes for preparing a catalyst composition are disclosed and described herein, and these processes can comprise (or consist essentially of, or consist of) (i) providing a metallocene solution comprising from 10 to 70 wt. % of a dihydrocarbyl metallocene compound in a first aliphatic hydrocarbon solvent, (ii) adding an amount of a second aliphatic hydrocarbon solvent to the metallocene solution to form a dilute solution comprising from 0.1 to 10 wt. % of the dihydrocarbyl metallocene compound, and (iii) contacting, in any order, the dilute solution, an activator-support, and an organoaluminum compound to form the catalyst composition.

Generally, the features of any of the processes disclosed herein (e.g., the activator-support, the organoaluminum compound, the dihydrocarbyl metallocene compound, the first aliphatic hydrocarbon solvent, and the second aliphatic hydrocarbon solvent, among others) are independently described herein, and these features can be combined in any combination to further describe the disclosed processes. Moreover, other process steps can be conducted before, during, and/or after any of the steps listed in the disclosed processes, unless stated otherwise. Additionally, catalyst compositions produced in accordance with the disclosed processes are within the scope of this disclosure and are encompassed herein.

Referring now to step (i) of the process for producing a catalyst composition, a metallocene solution comprising from 10 to 70 wt. % of a dihydrocarbyl metallocene compound in a first aliphatic hydrocarbon solvent is provided. In one aspect, the metallocene solution can comprise a single dihydrocarbyl metallocene compound, while in another aspect, the metallocene solution can comprise a single dihydrocarbyl metallocene compound and another metallocene compound that is not a dihydrocarbyl metallocene compound (e.g., a dihalide), and in yet another aspect, the metallocene solution can comprise two different dihydrocarbyl metallocene compounds, and in still another aspect, the metallocene solution can comprise three metallocene compounds, at least one of which is a dihydrocarbyl metallocene compound (and more often, all three are dihydrocarbyl metallocene compounds). For example, the metallocene solution can comprise a single bridged or a single unbridged dihydrocarbyl metallocene compound, or the metallocene solution can comprise (a mixture of) a bridged dihydrocarbyl metallocene compound and an unbridged dihydrocarbyl metallocene compound. Any suitable bridged and/or unbridged dihydrocarbyl metallocene compounds, or any bridged and/or unbridged dihydrocarbyl metallocene compounds disclosed herein, can be present in the metallocene solution. The process for producing a catalyst composition disclosed herein is also meant to encompass circumstances where more than one metallocene solution is present in step (i). As a non-limiting example, a first metallocene solution can contain a bridged dihydrocarbyl metallocene compound and a second metallocene solution can contain an unbridged dihydrocarbyl metallocene compound, and the first aliphatic hydrocarbon solvent can be the same or different in the first and second metallocene solutions. In this example, the first and second metallocene solutions can be mixed at any suitable relative amount prior to diluting in step (ii), or each metallocene solution can be diluted separately to form first and second dilute solutions, respectively, which can then be combined with the activator-support and the organoaluminum compound to form the catalyst composition.

For instance, the dihydrocarbyl metallocene compound can comprise a bridged zirconium or hafnium based metallocene compound with a cyclopentadienyl group and a fluorenyl group. Additionally or alternatively, the dihydrocarbyl metallocene compound can comprise an unbridged zirconium or hafnium based metallocene compound containing two cyclopentadienyl groups, two indenyl groups, or a cyclopentadienyl and an indenyl group. Additionally or alternatively, the dihydrocarbyl metallocene compound can comprise an unbridged zirconium based metallocene compound containing a cyclopentadienyl group and an indenyl group. Accordingly, the dihydrocarbyl metallocene compound can comprise any combination of bridged metallocene compounds and unbridged metallocene compounds disclosed herein, and therefore, the metallocene solution can comprise a mixture of two or more dihydrocarbyl metallocene compounds.

As disclosed herein, the dihydrocarbyl metallocene compound can comprise any suitable hydrocarbyl substituents. For example, and not limited thereto, the dihydrocarbyl metallocene compound can comprise (i) two hydrocarbyl substituents independently selected from a C₁ to C₁₈ hydrocarbyl group, (ii) two hydrocarbyl substituents independently selected from a methyl group, a phenyl group, and/or a benzyl group, (iii) two methyl group substituents, (iv) two phenyl group substituents, or (v) two benzyl group substituents.

Generally, the metallocene solution of step (i) can comprise from 10 to 70 wt. % of the dihydrocarbyl metallocene compound. If more than one dihydrocarbyl metallocene compound is present, this weight percentage is based on the total amount of dihydrocarbyl metallocene compounds. More often, the metallocene solution can comprise from 10 to 60 wt. %, from 10 to 40 wt. %, from 20 to 70 wt. %, from 20 to 50 wt. %, from 30 to 60 wt. %, or from 40 to 70 wt. % of the dihydrocarbyl metallocene compound. The high solubility of the dihydrocarbyl metallocene compound in the first aliphatic hydrocarbon solvent and, therefore, the high concentration of the dihydrocarbyl metallocene compound in the metallocene solution are incredibly beneficial for shipping and storage. For instance, instead of shipping and storing a dilute 1 wt. % solution, a highly concentrated 50 wt. % solution can be shipped and stored much more economically (e.g., smaller storage tanks and catalyst preparation vessels).

Typically, all or substantially all of the metallocene solution is the dihydrocarbyl metallocene compound(s) and the first aliphatic hydrocarbon solvent. In various aspects, the metallocene solution comprises at least 98 wt. %, at least 99 wt. %, at least 99.5 wt. %, or at least 99.9 wt. % of the dihydrocarbyl metallocene compound(s) and the first aliphatic hydrocarbon solvent.

In step (ii), the metallocene solution of step (i) is diluted by incorporating an amount of a second aliphatic hydrocarbon solvent to form a dilute solution. Typically, the resulting dilute solution can comprise from 0.1 to 10 wt. % of the dihydrocarbyl metallocene compound. For instance, the dilute solution can comprise from 0.1 to 8 wt. %, from 0.1 to 5 wt. %, from 0.5 to 10 wt. %, from 0.5 to 5 wt. %, from 1 to 10 wt. %, or from 1 to 5 wt. %, of the dihydrocarbyl metallocene compound.

With the addition of a second aliphatic hydrocarbon solvent in step (ii) of the process, naturally there is higher concentration of the dihydrocarbyl metallocene compound in the metallocene solution of step (i) as compared to the dilute solution in step (ii). Typically, a ratio of the dihydrocarbyl metallocene compound, in weight percent, in the metallocene solution to the dilute solution can be from 2:1 to 500:1; alternatively, from 2:1 to 100:1; or alternatively, from 5:1 to 50:1. Further, each of the metallocene solution and the dilute solution can be free of or substantially free of an aromatic solvent. Specifically, the metallocene solution and the dilute solution either do not comprise any aromatic solvent, or contain less than 1 wt. %, less than 0.1 wt. %, or less than 100 ppmw of an aromatic solvent.

As it pertains to the first aliphatic hydrocarbon solvent and the second aliphatic hydrocarbon solvent of step (i) and step (ii), any suitable aliphatic hydrocarbons can be utilized independently, such as alkanes and olefins. For example, the first aliphatic hydrocarbon solvent and the second aliphatic hydrocarbon solvent independently can comprise a linear or branched C₄-C₈ alkane; alternatively, butane, hexane, heptane, octane, or a mixture thereof; or alternatively, isobutane, hexane, heptane, or a mixture thereof. If the aliphatic hydrocarbon solvent is an olefin, the first aliphatic hydrocarbon solvent and the second aliphatic hydrocarbon solvent independently can comprise a linear C₄-C₁₂ α-olefin; alternatively, 1-butene, 1-pentene, 1-hexene, 1-heptene, 1-octene, 1-nonene, 1-decene, or a mixture thereof; or alternatively, 1-hexene. In some aspects, the first aliphatic hydrocarbon solvent can be the same as the second aliphatic hydrocarbon solvent, while in other aspects, the first aliphatic hydrocarbon solvent can be a different solvent from the second aliphatic hydrocarbon solvent. For instance, the first aliphatic hydrocarbon solvent and the second aliphatic hydrocarbon solvent can be the same alkane solvent (e.g., heptane) or the first aliphatic hydrocarbon solvent and the second aliphatic hydrocarbon solvent can be the same olefin solvent (e.g., 1-hexene), or the first aliphatic hydrocarbon solvent can be an alkane solvent (e.g., hexane and/or heptane), and the second aliphatic hydrocarbon solvent can be a different alkane solvent (e.g., isobutane), or the first aliphatic hydrocarbon solvent can be an alkane solvent and the second aliphatic hydrocarbon solvent can be an olefin solvent, or the first aliphatic hydrocarbon solvent can be an olefin solvent and the second aliphatic hydrocarbon solvent can be an alkane solvent.

In step (iii) of the disclosed process to produce a catalyst composition, the dilute solution, an activator support, and an organoaluminum compound can be contacted to form the catalyst composition. Generally, the dilute solution, the activator support, and the organoaluminum compound can be contacted in any order.

In certain aspects, contacting the dilute solution, the activator support, and the organoaluminum compound in step (iii) can comprise (a) contacting the activator-support and the organoaluminum compound to form a pre-contacted mixture and (b) contacting the pre-contacted mixture with the dilute solution to form the catalyst composition. Often, contacting the activator-support and the organoaluminum compound to form a pre-contacted mixture (in a so-called “pre-contacting step”) can proceed for a first period of time. Additionally, contacting the pre-contacted mixture with the dilute solution to form the catalyst composition can proceed for a second period of time. The duration of the pre-contacting step (or the first period of time) is not limited to any particular period of time, so long as the first period of time is sufficient for any reaction between the activator-support and the organoaluminum compound to occur, thus forming the pre-contacted mixture. Similarly, the duration of the second time period is not limited to any particular period of time, so long as the second period of time is sufficient for any reaction between the pre-contacted mixture and the dilute solution (containing the dihydrocarbyl metallocene compound) to occur, thus forming the catalyst composition.

In further aspects, step (iii) can comprise contacting the dilute solution and the organoaluminum compound, in any order, with a slurry of the activator-support in a suitable diluent. Additionally or alternatively, the dilute solution and the activator-support can be contacted, in any order, with a co-catalyst solution of the organoaluminum compound in a hydrocarbon solvent. The diluent and the hydrocarbon solvent typically can be a suitable alkane, such as a C₄-C₈ alkane.

Step (i), step (ii), and step (iii) of the process to produce a catalyst composition can be conducted independently at varying temperatures. For instance, step (i) can be conducted at a temperature in a range from −15° C. to 60° C.; alternatively, from −5° C. to 40° C.; alternatively, from −5° C. to 20° C.; alternatively, from 5° C. to 30° C.; alternatively, from 5° C. to 20° C.; alternatively, from 10° C. to 60° C.; or alternatively, from 10° C. to 30° C. Likewise, step (ii) can be conducted at a temperature in a range from −15° C. to 60° C.; alternatively, from −5° C. to 40° C.; alternatively, from −5° C. to 20° C.; alternatively, from 5° C. to 30° C.; alternatively, from 5° C. to 20° C.; alternatively, from 10° C. to 60° C.; or alternatively, from 10° C. to 30° C. Step (iii) can be conducted at a temperature in a range from −15° C. to 60° C.; alternatively, from −5° C. to 40° C.; alternatively, from −5° C. to 20° C.; alternatively, from 5° C. to 30° C.; alternatively, from 5° C. to 20° C.; alternatively, from 10° C. to 60° C.; or alternatively, from 10° C. to 30° C. In these and other aspects, these temperature ranges are also meant to encompass circumstances where each of step (i), step (ii), and/or step (iii) is conducted at a series of different temperatures, instead of at a single fixed temperature, falling within the respective ranges, wherein at least one temperature falls within the respective ranges. Beneficially, any one or more of step (i), step (ii), and/or step (iii) can be performed at ambient temperature conditions, or any one or more of more of step (i), step (ii), and/or step (iii) can be performed at sub-ambient conditions, in which the dihydrocarbyl metallocene compound remains soluble in the metallocene solution and the dilute solution. Thus, and advantageously, heated transfer lines, heated storage tanks, heating mixing tanks, and the like, are typically not required to maintain the metallocene compound in solution. Likewise, for transport of the metallocene solution, heated shipping trucks are typically not required to maintain the metallocene compound in solution, despite the high metallocene concentration (e.g., 10-70 wt./0)

Suitable activator-supports are disclosed herein and can include a fluorided solid oxide and/or a sulfated solid oxide. In an aspect, the activator-support can comprise fluorided silica-alumina, fluorided silica-coated alumina, sulfated alumina, or a combination thereof. Suitable organoaluminum compounds also are disclosed herein and can include trimethylaluminum (TMA), triethylaluminum (TEA), tri-n-propylaluminum (TNPA), tri-n-butylaluminum (TNBA), triisobutylaluminum (TIBA), tri-n-hexylaluminum, tri-n-octylaluminum (TNOA), or a combination thereof.

In some aspects, the process of producing a catalyst composition (and the catalyst composition produced) is substantially free of aluminoxane compounds, organoborate compounds, ionizing ionic compounds, and/or other similar materials; alternatively, substantially free of aluminoxanes; alternatively, substantially free or organoboron or organoborate compounds; or alternatively, substantially free of ionizing ionic compounds. For instance, the catalyst composition can contain less than 500 ppm, less than 100 ppm, less than 10 ppm, or less than 1 ppm (by weight), independently, of aluminoxanes, organoboron or organoborate compounds, and ionizing ionic compounds.

With the catalyst compositions formed according to the process described herein, olefin polymers (e.g., ethylene polymers) can be produced through any suitable olefin polymerization process using various types of polymerization reactors, polymerization reactor systems, and polymerization reaction conditions as further described herein. These polymerization processes can produce a suitable olefin polymer from which various articles of manufacture can be formed. A useful such polymerization process can comprise performing any process to produce the catalyst composition described herein, and contacting the catalyst composition with an olefin monomer and an optional olefin comonomer in a polymerization reactor system under polymerization conditions to produce an olefin polymer. Additionally, or alternatively, a polymerization process can comprise contacting any catalyst composition described herein with an olefin monomer and an optional olefin comonomer in a polymerization reactor system under polymerization conditions to produce an olefin polymer. Often, the olefin monomer of the polymerization process comprises ethylene. According to certain aspects, the olefin comonomer can be present. Non-limiting examples of suitable olefin comonomers include, but are not limited to, 1-butene, 1-hexene, 1-octene, or a mixture thereof. Olefin polymers formed from the polymerization process described herein can include any polymer produced from any olefin monomer (and optional comonomer(s)). For example, the olefin polymer can comprise an ethylene homopolymer, an ethylene/1-butene copolymer, an ethylene/1-hexene copolymer, and/or an ethylene/1-octene copolymer. Further information on polymerizations processes is provided below.

### Polymerization Processes

Polymerization processes of the present invention can comprise contacting a catalyst composition (any catalyst composition disclosed herein, and any metallocene solution disclosed herein) with an olefin monomer and an optional olefin comonomer in a polymerization reactor system under polymerization conditions to produce an olefin polymer. Often, the metallocene solution containing the metallocene compound and the aliphatic hydrocarbon solvent can be fed to a catalyst preparation vessel that contains the activator-support and the organoaluminum compound to form the catalyst composition. In this aspect, the catalyst composition is effectively formed in the catalyst preparation vessel, prior to being fed to a reactor in the polymerization reactor system.

As used herein, a “polymerization reactor” includes any polymerization reactor capable of polymerizing olefin monomers and comonomers (one or more than one comonomer) to produce homopolymers, copolymers, terpolymers, and the like. The various types of polymerization reactors include those that can be referred to as a batch reactor, slurry reactor, gas-phase reactor, solution reactor, high pressure reactor, tubular reactor, autoclave reactor, and the like, or combinations thereof, or alternatively, the polymerization reactor system can comprise a slurry reactor, a gas-phase reactor, a solution reactor, a multizone circulating reactor, or a combination thereof. The polymerization conditions for the various reactor types are well known to those of skill in the art. Gas phase reactors can comprise fluidized bed reactors or staged horizontal reactors. Slurry reactors can comprise vertical or horizontal loops. High pressure reactors can comprise autoclave or tubular reactors. Reactor types can include batch or continuous processes. Continuous processes can use intermittent or continuous product discharge. Polymerization reactor systems and processes also can include partial or full direct recycle of unreacted monomer, unreacted comonomer, and/or diluent.

A polymerization reactor system can comprise a single reactor or multiple reactors (2 reactors, more than 2 reactors) of the same or different type. For instance, the polymerization reactor system can comprise a slurry reactor, a gas-phase reactor, a solution reactor, or a combination of two or more of these reactors. Production of polymers in multiple reactors can include several stages in at least two separate polymerization reactors interconnected by a transfer device making it possible to transfer the polymer resulting from the first polymerization reactor into the second reactor. The desired polymerization conditions in one of the reactors can be different from the operating conditions of the other reactor(s). Alternatively, polymerization in multiple reactors can include the manual transfer of polymer from one reactor to subsequent reactors for continued polymerization. Multiple reactor systems can include any combination including, but not limited to, multiple loop reactors, multiple gas phase reactors, a combination of loop and gas phase reactors, multiple high pressure reactors, or a combination of high pressure with loop and/or gas phase reactors. The multiple reactors can be operated in series, in parallel, or both. Accordingly, the present invention encompasses polymerization reactor systems comprising a single reactor, comprising two reactors, and comprising more than two reactors. The polymerization reactor system can comprise a slurry reactor, a gas-phase reactor, a solution reactor, in certain aspects of this invention, as well as multi-reactor combinations thereof.

According to one aspect, the polymerization reactor system can comprise at least one loop slurry reactor comprising vertical or horizontal loops. Monomer, diluent, catalyst, and comonomer can be continuously fed to a loop reactor where polymerization occurs. Generally, continuous processes can comprise the continuous introduction of monomer/comonomer, a catalyst, and a diluent into a polymerization reactor and the continuous removal from this reactor of a suspension comprising polymer particles and the diluent. Reactor effluent can be flashed to remove the solid polymer from the liquids that comprise the diluent, monomer and/or comonomer. Various technologies can be used for this separation step including, but not limited to, flashing that can include any combination of heat addition and pressure reduction, separation by cyclonic action in either a cyclone or hydrocyclone, or separation by centrifugation.

A typical slurry polymerization process (also known as the particle form process) is disclosed, for example, in U.S. Pat. Nos. 3,248,179, 4,501,885, 5,565,175, 5,575,979, 6,239,235, 6,262,191, 6,833,415, and 8,822,608.

Suitable diluents used in slurry polymerization include, but are not limited to, the monomer being polymerized and hydrocarbons that are liquids under reaction conditions. Examples of suitable diluents include, but are not limited to, hydrocarbons such as propane, cyclohexane, isobutane, n-butane, n-pentane, isopentane, neopentane, and n-hexane. Some loop polymerization reactions can occur under bulk conditions where no diluent is used.

According to yet another aspect, the polymerization reactor system can comprise at least one gas phase reactor (e.g., a fluidized bed reactor). Such reactor systems can employ a continuous recycle stream containing one or more monomers continuously cycled through a fluidized bed in the presence of the catalyst under polymerization conditions. A recycle stream can be withdrawn from the fluidized bed and recycled back into the reactor. Simultaneously, polymer product can be withdrawn from the reactor and new or fresh monomer can be added to replace the polymerized monomer. Such gas phase reactors can comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone. Representative gas phase reactors are disclosed in U.S. Pat. Nos. 5,352,749, 4,588,790, 5,436,304, 7,531,606, and 7,598,327.

The polymerization reactor system can further comprise any combination of at least one raw material feed system, at least one feed system for catalyst or catalyst components, and/or at least one polymer recovery system. Suitable reactor systems can further comprise systems for feedstock purification, catalyst storage and preparation, extrusion, reactor cooling, polymer recovery, fractionation, recycle, storage, loadout, laboratory analysis, and process control. Depending upon the desired properties of the olefin polymer, hydrogen can be added to the polymerization reactor as needed (e.g., continuously or pulsed).

Polymerization conditions that can be controlled for efficiency and to provide desired polymer properties can include temperature, pressure, and the concentrations of various reactants. Polymerization temperature can affect catalyst productivity, polymer molecular weight, and molecular weight distribution. Various polymerization conditions can be held substantially constant (such as within +/−20%, +/−10%, or +/−5%), for example, for the production of a particular grade of the olefin polymer (or ethylene polymer). A suitable polymerization temperature can be any temperature below the de-polymerization temperature according to the Gibbs Free energy equation. Typically, this includes from 60° C. to 280° C., for example, or from 60° C. to 120° C., depending upon the type of polymerization reactor(s). In some reactor systems, the polymerization temperature generally can be within a range from 70° C. to 105° C., or from 75° C. to 100° C.

Suitable pressures will also vary according to the reactor and polymerization type. The pressure for liquid phase polymerizations in a loop reactor is typically less than 1000 psig (6.90 MPa). Pressure for gas phase polymerization is usually at 200 to 500 psig (1.38 MPa to 3.45 MPa). Thus in certain aspects, polymerization conditions can include a pressure in a range from 200 psig (1.38 MPa) to 1000 psig (6.90 MPa). High pressure polymerization in tubular or autoclave reactors is generally run at 20,000 to 75,000 psig (138 to 517 MPa). Polymerization reactors can also be operated in a supercritical region occurring at generally higher temperatures and pressures. Operation above the critical point of a pressure/temperature diagram (supercritical phase) can offer advantages to the polymerization reaction process.

The concentration of the reactants entering the polymerization reactor can be controlled to produce resins with certain physical and mechanical properties. The proposed end-use product that will be formed by the polymer resin and the method of forming that product ultimately can determine the desired polymer properties and attributes. Mechanical properties include tensile, flexural, impact, creep, stress relaxation, and hardness tests. Physical properties include density, molecular weight, molecular weight distribution, melting temperature, glass transition temperature, stereoregularity, crack growth, long chain branching, and rheological measurements.

Olefin monomers that can be employed with the polymerization processes of this invention can include olefin compounds having from 2 to 30 carbon atoms per molecule and having at least one olefinic double bond, such as ethylene or propylene. In an aspect, the olefin monomer can comprise a C₂-C₂₀ olefin; alternatively, a C₂-C₂₀ alpha-olefin; alternatively, a C₂-C₁₀ olefin; alternatively, a C₂-C₁₀ alpha-olefin; alternatively, the olefin monomer can comprise ethylene; or alternatively, the olefin monomer can comprise propylene (e.g., to produce a polypropylene homopolymer or a propylene-based copolymer).

When a copolymer (or alternatively, a terpolymer) is desired, the olefin monomer and the olefin comonomer independently can comprise, for example, a C₂-C₂₀ alpha-olefin. In some aspects, the olefin monomer can comprise ethylene or propylene, which is copolymerized with at least one comonomer (e.g., a C₂-C₂₀ alpha-olefin or a C₃-C₂₀ alpha-olefin). According to one aspect of this invention, the olefin monomer used in the polymerization process can comprise ethylene. In this aspect, the comonomer can comprise a C₃-C₁₀ alpha-olefin; alternatively, the comonomer can comprise 1-butene, 1-pentene, 1-hexene, 1-octene, 1-decene, styrene, or any combination thereof; alternatively, the comonomer can comprise 1-butene, 1-hexene, 1-octene, or any combination thereof; alternatively, the comonomer can comprise 1-butene; alternatively, the comonomer can comprise 1-hexene; or alternatively, the comonomer can comprise 1-octene.

The amount of the catalyst composition used in the polymerization process can be quantified by the concentration of its individual components in comparison to the total weight of the polymerization reaction medium (e.g., diluent). The amount of the metallocene compound is not particularly limited, but generally can fall in a range from 0.01 ppmw to 100 ppmw (ppm by weight), based on the diluent. More often, the amount of the metallocene compound can be in a range from 0.1 ppmw to 10 ppmw or from 1 ppmw to 5 ppmw. Additionally or alternatively, the amount of each of the organoaluminum compound and the activator utilized in the polymerization process independently can be in a range from 1 ppmw to 10,000 ppmw; alternatively from 10 ppmw to 2,500 ppmw; or alternatively from 50 ppmw to 1,000 ppmw, based on the total weight of the polymerization reaction medium (e.g., diluent).

When used, hydrogen can be fed directly to the reactor, or hydrogen can be combined with an ethylene feed prior to the reactor (e.g., at a H₂/ethylene feed ratio in a range from 1 to 1000 ppmw. Alternatively, hydrogen is not added during the polymerization process in other aspects.

### Polymers and Articles

The olefin polymers of this invention can include any polymer produced from any olefin monomer and optional comonomer(s) described herein. For example, the olefin polymer can comprise an ethylene homopolymer, an ethylene copolymer (e.g., ethylene/α-olefin, ethylene/1-butene, ethylene/1-hexene, ethylene/1-octene, etc.), a propylene homopolymer, a propylene copolymer, an ethylene terpolymer, a propylene terpolymer, and the like, including any combinations thereof. In one aspect, the olefin polymer can comprise an ethylene homopolymer, an ethylene/1-butene copolymer, an ethylene/1-hexene copolymer, and/or an ethylene/1-octene copolymer, while in another aspect, the olefin polymer can comprise an ethylene/1-hexene copolymer.

If the resultant polymer produced in accordance with the present invention is, for example, an ethylene polymer, its properties can be characterized by various analytical techniques known and used in the polyolefin industry.

For instance, an illustrative and non-limiting example of an olefin polymer (e.g., an ethylene/α-olefin copolymer) produced using the catalyst compositions disclosed herein can have a Mz from 100,000 to 5,000,000 g/mol, a Mw from 50,000 to 1,800,000 g/mol, a Mn from 10,000 to 200,000 g/mol, a ratio of Mw/Mn from 2 to 40, and a ratio of Mz/Mw from 1.5 to 5. In certain aspects, the olefin polymer can be an ethylene/1-hexene copolymer having a melt index (MI) from 0.01 to 10 g/10 min, a high load melt index (HLMI) from 0.1 to 100 g/10 min, and a ratio of HLMI/MI from 10 to 100. In another illustrative and non-limiting example, an ethylene polymer (e.g., an ethylene/α-olefin copolymer) can have a Mw/Mn from 2.2 to 30, a Mz/Mw from 1.6 to 4, a Mw from 85,000 to 1,000,000 g/mol, a Mn from 15,000 to 100,000 g/mol, and a Mz from 150,000 to 3,000,000 g/mol. Ethylene polymers consistent with the present invention also can have any of the polymer properties listed below, and in any combination, unless indicated otherwise.

In an aspect, the ethylene polymers can have a CY-a parameter from 0.2 to 0.6, from 0.25 to 0.6, from 0.3 to 0.6, from 0.4 to 0.6, or from 0.5 to 0.6. These rheological parameters are determined from viscosity data measured at 190° C. and using the Carreau-Yasuda (CY) empirical model described herein.

Ethylene polymers described herein often can have a melt index (MI) of less than or equal to 15 g/10 min, less than or equal to 10 g/10 min, or less than or equal to 5 g/10 min. In further aspects, ethylene polymers described herein can have a melt index (MI) in a range from 0.01 to 10 g/10 min, from 0.1 to 5 g/10 min, from 0.4 to 4 g/10 min, or from 0.75 to 2.75 g/10 min. While not being limited thereto, the ethylene polymer also can have a high load melt index (HLMI) in a range from 0.1 to 100 g/10 min; alternatively, from 1 to 50 g/10 min; or alternatively, from 5 to 25 g/10 min. The ratio of high load melt index (HLMI) to melt index (MI), referred to as the ratio of HLMI/MI, is not particularly limited, but typically ranges from 10 to 100, from 15 to 75, from 15 to 50, from 15 to 35, or from 15 to 25. In this HLMI/MI ratio, the melt index is not equal to zero.

In an aspect, ethylene polymers described herein can have a weight-average molecular weight (Mw) in a range from 50,000 to 1,800,000, from 85,000 to 1,200,000, from 85,000 to 1,000,000, or from 120,000 to 800,000 g/mol. Additionally or alternatively, the ethylene polymer can have a number-average molecular weight (Mn) in a range from 10,000 to 200,000 g/mol, from 15,000 to 150,000 g/mol, from 15,000 to 100,000 g/mol, or from 20,000 to 80,000 g/mol. Additionally or alternatively, the ethylene polymer can have a z-average molecular weight (Mz) in a range from 100,000 to 5,000,000 g/mol, from 150,000 to 3,000,000 g/mol, or from 200,000 to 2,500,000 g/mol.

In an aspect, ethylene polymers described herein can have a ratio of Mw/Mn, or the polydispersity index, in a range from 2 to 40, from 2.2 to 30, from 2.2 to 5, or from 10 to 35. Additionally or alternatively, the ethylene polymer can have a ratio of Mz/Mw in a range from 1.5 to 5, from 1.6 to 4, or from 1.7 to 3.5.

Articles of manufacture can be formed from, and/or can comprise, the olefin polymers (e.g., ethylene polymers) of this invention and, accordingly, are encompassed herein. For example, articles which can comprise the polymers of this invention can include, but are not limited to, an agricultural film, an automobile part, a bottle, a container for chemicals, a drum, a fiber or fabric, a food packaging film or container, a food service article, a fuel tank, a geomembrane, a household container, a liner, a molded product, a medical device or material, an outdoor storage product (e.g., panels for walls of an outdoor shed), outdoor play equipment (e.g., kayaks, bases for basketball goals), a pipe, a sheet or tape, a toy, or a traffic barrier, and the like. Various processes can be employed to form these articles. Non-limiting examples of these processes include injection molding, blow molding, rotational molding, film extrusion, sheet extrusion, profile extrusion, thermoforming, and the like. Additionally, additives and modifiers often are added to these polymers in order to provide beneficial polymer processing or end-use product attributes. Such processes and materials are described in Modern Plastics Encyclopedia, Mid-November 1995 Issue, Vol. 72, No. 12; and Film Extrusion Manual—Process, Materials, Properties, TAPPI Press, 1992. In some aspects of this invention, an article of manufacture can comprise any of olefin polymers (or ethylene polymers) described herein, and the article of manufacture can be or can comprise a film (e.g., a blown film), a pipe, or a blow molded product.

In some aspects, the article produced from and/or comprising an ethylene polymer of this invention is a film product. For instance, the film can be a blown film or a cast film that is produced from and/or comprises any of the ethylene polymers disclosed herein. Such films also can contain one or more additives, non-limiting examples of which can include an antioxidant, an acid scavenger, an antiblock additive, a slip additive, a colorant, a filler, a processing aid, a UV inhibitor, and the like, as well as combinations thereof.

Films disclosed herein, whether cast or blown, can be any thickness that is suitable for the particular end-use application, and often, the average film thickness can be in a range from 0.25 to 250 mils, or from 0.5 to 20 mils. For certain film applications, typical average thicknesses can be in a range from 0.25 to 8 mils, from 0.5 to 8 mils, from 0.8 to 5 mils, or from 0.7 to 2 mils.

The film products encompassed herein also can be characterized by optical properties, such as low haze. As one of skill in the art would readily recognize, certain additives can adversely impact haze and other optical properties, for example, slip and antiblock additives. Nonetheless, the film products encompassed herein can have a haze (with or without additives) of less than or equal to 10%, less than or equal to 9%, less than or equal to 8%, less than or equal to 7%, and often can have haze values ranging from 2 to 10%, from 2 to 6%, from 2 to 5%, or from 3 to 4%, and the like.

In an aspect and unexpectedly, the blown films or cast films disclosed herein can have excellent tear resistance. Further, such films also can generally have low haze and good optical properties. For instance, the tear resistance of the films described herein can be characterized by the MD (or TD) Elmendorf tear strength. Suitable ranges for the MD tear strength can include, but are not limited to, from 40 to 400 g/mil (1.57 to 15.75 g/μm), from 75 to 375 g/mil (2.95 to 14.76 g/μm), from 100 to 350 g/mil (3.94 to 13.78 g/μm), from 125 to 325 g/mil (4.92 to 12.80 g/μm), or from 150 to 300 g/mil (5.91 to 11.81 g/μm), and the like. Typical ranges for the TD tear strength can include, but are not limited to, from 150 to 600 g/mil (5.91 to 23.62 g/μm), from 225 to 550 g/mil (8.86 to 21.65 g/μm), or from 300 to 450 g/mil (11.81 to 17.72 g/μm), and the like. While not being limited thereto, the blown film or cast film can have a ratio of TD Elmendorf tear strength to MD Elmendorf tear strength (TD:MD) in a range from 1:1 to 10:1, from 1:1 to 5:1, from 2:1 to 5:1, or from 2.5:1 to 4:1.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Melt index (MI, g/10 min) was determined in accordance with ASTM D1238 at 190° C. with a 2,160 gram weight, and high load melt index (HLMI, g/10 min) was determined in accordance with ASTM D1238 at 190° C. with a 21,600 gram weight. Density was determined in grams per cubic centimeter (g/cm³) on a compression molded sample, cooled at 15° C. per minute, and conditioned for 40 hours at room temperature in accordance with ASTM D1505 and ASTM D4703.

Dart impact strength (g/mil) was measured in accordance with ASTM D1709 (method A). Film machine direction (MD) and transverse direction (TD) Elmendorf tear strengths (g/mil) were measured on a Testing Machines tear tester (Model 83-11-00) in accordance with ASTM D1922. Film haze (%) was determined in accordance with ASTM D1003, and film clarity (%) was determined in accordance with ASTM 105.

Molecular weights and molecular weight distributions were obtained using a PL-GPC 220 (Polymer Labs, an Agilent Company) system equipped with a IR4 detector (Polymer Char, Spain) and three Styragel® HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were in the range of 1.0-1.5 mg/mL, depending on the molecular weight. Sample preparation was conducted at 150° C. for nominally 4 hr with occasional and gentle agitation, before the solutions were transferred to sample vials for injection. An injection volume of 200 μL was used. The integral calibration method was used to deduce molecular weights and molecular weight distributions using a Chevron Phillips Chemical Company's HDPE polyethylene resin, MARLEX® BHB5003, as the broad standard. The integral table of the broad standard was pre-determined in a separate experiment with SEC-MALS. Mn is the number-average molecular weight, Mw is the weight-average molecular weight, Mz is the z-average molecular weight, Mv is viscosity-average molecular weight, and Mp is the peak molecular weight (location, in molecular weight, of the highest point of the molecular weight distribution curve).

Melt rheological characterizations were performed as follows. Small-strain (less than 10%) oscillatory shear measurements were performed on an Anton Paar MCR rheometer using parallel-plate geometry. All rheological tests were performed at 190° C. The complex viscosity |η*| versus frequency (ω) data were then curve fitted using the modified three parameter Carreau-Yasuda (CY) empirical model to obtain the zero shear viscosity—η₀, characteristic viscous relaxation time—τ_{η}, and the breadth parameter—a (CY-a parameter). The simplified Carreau-Yasuda (CY) empirical model is as follows.

$$\vert η * ( ω ) \vert = \frac{η0}{{[ 1 + {( {τ}_{n} ω )}^{a} ]}^{\frac{1 - n}{a}}} ,$$

wherein: |η*(ω)|=magnitude of complex shear viscosity;
η₀=zero shear viscosity;
τ_{η}=viscous relaxation time (Tau(η));
a=“breadth” parameter (CY-a parameter);
n=fixes the final power law slope, fixed at 2/11; and
ω=angular frequency of oscillatory shearing deformation.

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong and O. Hasseger, Dynamics of Polymeric Liquids, Volume 1, Fluid Mechanics, 2nd Edition, John Wiley & Sons (1987).

Structures for MET-1 and MET-2 and MET-3 used in Examples 1-31 are shown below (Me is methyl, Bn is benzyl, and t-Bu is tert-butyl).

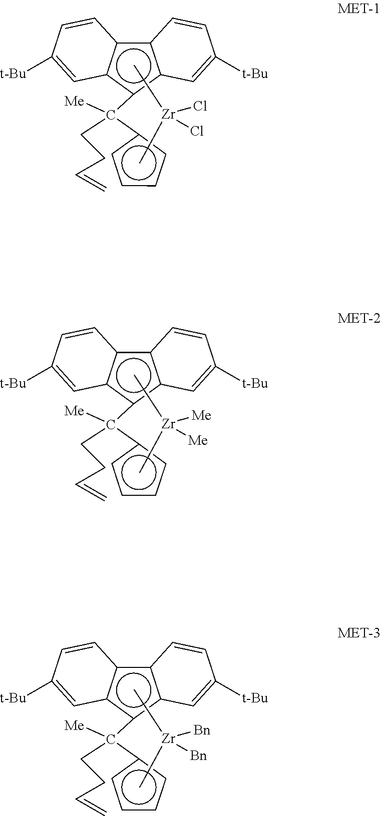

The solubility for each of MET-1, MET-2, and MET-3 in both heptane and 1-hexene were determined by dissolving a maximum amount of the respective metallocene compound according to the following procedure. A given amount of the metallocene was slurried in a small amount of a solvent in a container with a stir bar on a stir plate at 25° C. Solvent was then slowly added in small increments and stirred for 5 minutes after each increment until all the solid metallocene was dissolved. The solubility of MET-1 was low in both solvents, with only 0.29 wt. % dissolved MET-1 in 1-hexene, and roughly half that amount (0.14 wt. %) in heptane. Surprisingly, MET-2 demonstrated an incredible increase in solubility relative to MET-1 for each solvent. The solubility of MET-2 in each of 1-hexene (7.9 wt. %) and heptane (3.7 wt. %) was increased by more than 25-fold. The solubility of MET-3 also demonstrated a similarly surprising improvement in each solvent (2.4 wt. % in 1-hexene; 1.1 wt. % in heptane) representing an 8-fold increase in each case.

Polymerization reactions using MET-1, MET-2, and MET-3 were conducted to evaluate the effect of the metallocene structure (Me and Bn versus Cl) and improved solubility on polymerization reaction properties (e.g., catalyst activity and productivity) and product characteristics (e.g., molecular weights and film properties). The organoaluminum compounds used in the examples are abbreviated as follows: TIBA is triisobutylaluminum, TNBA is tri-n-butylaluminum, TNOA is tri-n-octylaluminum, TEA is triethylaluminum, and TMA is trimethylaluminum.

Polymerization reactions using MET-1 were characterized as Comparative Examples C1-C19, and polymerization reactions using MET-2 or MET-3 were characterized as Inventive Examples 1-31. Results of the polymerization reactions are summarized in Tables I-III.

### Examples 1-24 and Comparative Examples C1-C17

Examples 1-24 and Comparative Examples C1-C17 were conducted at bench scale using a one-gallon (3.8 L) stainless-steel autoclave reactor containing isobutane as diluent. 150 mg of a fluorided silica-coated alumina activator-support (A-S), the desired amount of organoaluminum compound (1.0 M in heptane), and an amount of the metallocene solution corresponding to 1.0 mg of metallocene were added in that order through a charge port while slowly venting isobutane vapor to form the catalyst compositions of Examples 1-24 and Comparative Examples C1-C17. The charge port was then closed, and isobutane was added. The contents of the reactor were stirred and heated to the desired run temperature of 80° C., and ethylene was then introduced into the reactor. Ethylene was fed on demand to maintain the target pressure of 270 or 320 psig (1.86 or 2.21 MPa). 1-hexene was fed on demand throughout the reaction as indicated in Table I. The reactor was maintained at the desired temperature throughout the experiment by an automated heating-cooling system. After venting of the reactor, purging, and cooling, the resulting polymer product was dried at 50° C. under vacuum.

Table I summarizes the conditions and results of bench scale polymerization reactions for Examples 1-24 and Comparative Examples C1-C17, and Table II summarizes the polymer product characteristics for Examples 1-24 and Comparative Examples C1-C17.

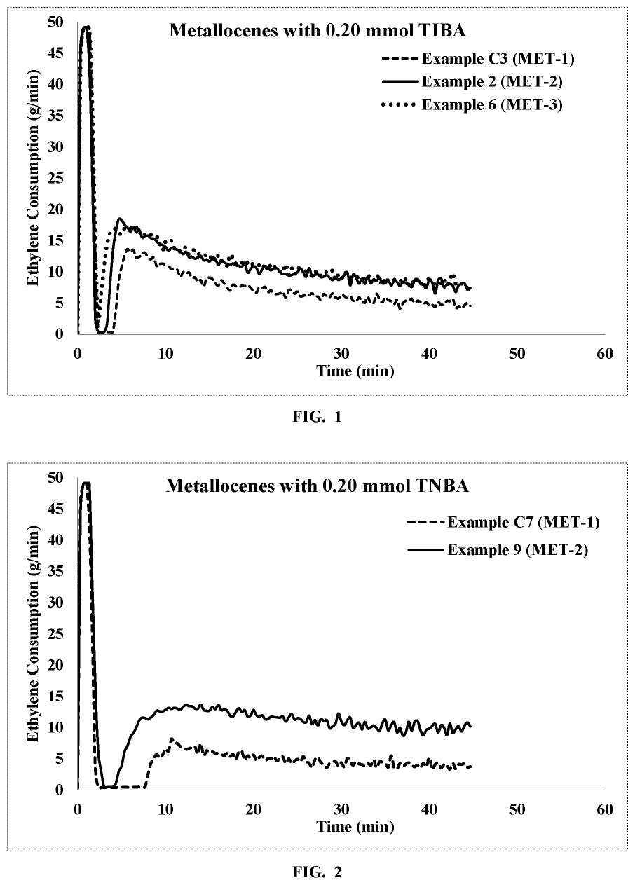

The polymerization reactions summarized in Table I compare the results from three different metallocenes (MET-1, MET-2, and MET-3), several organoaluminum compounds (TIBA, TNBA, TNOA, TEA, TMA), and various concentrations of the organoaluminum compounds. Comparative examples C1-C17 used MET-1, whereas each of Inventive Examples 1-24 examined analogous polymerization reactions using MET-2 or MET-3. For instance (and as shown in FIG. 1), Comparative Examples C1-C4 employed MET-1 in combination with TIBA in various amounts (0.05 mmol, 0.10 mmol, 0.20 mmol, and 0.40 mmol). Inventive Examples 1-3 were similar reactions using MET-2, and Inventive Examples 4-7 were similar reactions using MET-3.

Surprisingly, as shown in Table I, each of the metallocene productivity and metallocene activity were significantly higher for Examples 1-7 with MET-2 or MET-3 than that observed for the comparative examples using MET-1 having identical amounts of TIBA. For instance, Example C3 using MET-1 had a metallocene activity of 344,933 g/g/hr. Incredibly, the metallocene activity of Example 2 (MET-2) under the identical conditions was 50% higher at 519,867 g/g/hr. Example 6 (MET-3) had an even higher activity of 545,600 g/g/hr. FIG. 1 further illustrates the increase in activity according to the increased ethylene consumption for Examples 2 and 6, which was markedly higher throughout the polymerization reaction than that for Comparative Example C2.

Even more surprising, the increased activity observed when using MET-2 and MET-3 was not as dependent on the nature and amount of the organoaluminum compound used relative to Comparative Examples. Indeed, the increases in metallocene activity and metallocene productivity for inventive examples using MET-2 and MET-3 were even more pronounced using organoaluminum compounds other than TIBA. This versatility of the dialkylated metallocene with respect to the organoaluminum compounds suitable for use in the reaction is shown in Examples 8-11, 12, 13-18, and 19-24 for TNBA, TNOA, TEA and TMA, respectively.

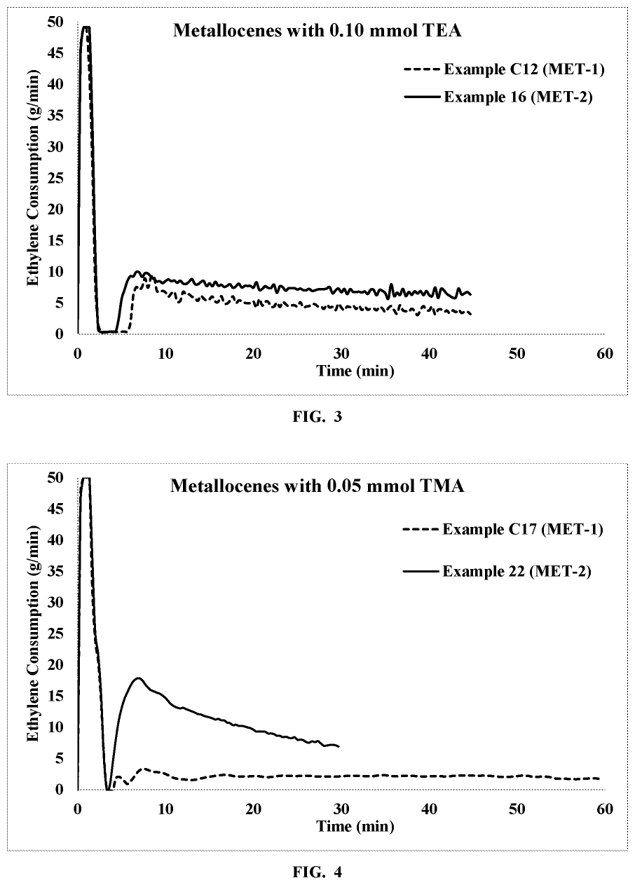

Examples using TNBA as the organoaluminum (Comparative Examples C5-C9 and Examples 8-11) showed the activity and productivity more than doubled for Examples 8-11. FIG. 2 shows representative examples using 0.20 mmol TNBA, and as for FIG. 2, ethylene consumption for Example 9 was markedly higher throughout the polymerization reaction than that for Comparative Example C7. Pronounced increases in the metallocene activity and metallocene productivity were also observed when using TNOA (Comparative Examples C10 and Example 12), TEA (comparative Examples C11-C14 and Examples 13-18; see FIG. 3), and TMA (Comparative Examples C15-C17 and Examples 19-24; see FIG. 4).

Examples using TMA in particular showed a vast disparity in metallocene activity and productivity, where even minor amounts of the organoaluminum compound appeared to eliminate the activity of MET-1 entirely. This effect was attenuated when MET-2 was used, which resulted in about 120% increase in metallocene activity at lower levels of the organoaluminum compound (see Comparative Example 17, and Examples 22 and 24) and a metallocene activity of 590,000 g/g/hr that was beyond that observed for any other examples using TMA at only 0.05 mmol of the organoaluminum compound. Examples 23-24 confirm the results of Example 22 were attributed to the organoaluminum compound.

Thus, from the results presented in Table I and FIGS. 1-4, it was demonstrated that the dihydrocarbyl metallocene compounds showed a surprising increase in catalytic activity in polymerization reactions and further surprising versatility with respect to the organoaluminum compounds suitable for use in the reactions. The ability to use a number of different organoaluminum compounds in the catalyst composition allows for practical improvements including reduced cost without sacrificing the activity and productivity of the metallocene compounds.

Table II summarizes polymer property data for Comparative Examples C1-C17 and Inventive Examples 1-24. Without being limited by theory, dialkylated metallocene compounds may be useful to improve solubility, activity, and reagent versatility as described above; however, if the resulting polymer products are not sufficiently similar or better to those produced by the non-alkylated metallocene analogs, then dihydrocarbyl metallocene compounds may be poor substitutes despite their advantages shown above. As shown in Table II, this was not the case. Dihydrocarbyl metallocene compounds MET-2 and MET-3 (Examples 1-24) produced ethylene polymers having properties similar to those produced using MET-1 (Comparative Examples C1-C17). Looking at certain TIBA examples (Examples C3, 2 and 6), each of Mn, Mw, Mz, Mw/Mn, and Mz/Mw for the inventive examples remained within 20% of those values for the comparative example using MET-1 under identical conditions. In several instances, the difference in polymer properties was much less than 20% relative to the product of MET-1 catalyzed polymerizations, e.g., within 15%, within 10%, within 5%, or within 3%.

Alternatively, or additionally, the difference in product values can represent an improvement over the product of MET-1 catalyzed polymerizations. Looking again at Table II, Example 2 had a CY-a parameter of 0.565 relative to 0.436 for the MET-1 catalyzed product of Comparative Example 3. Thus, while the overall polymer products produced using the dialkylated metallocene compounds remained fairly consistent with those produced using non-alkylated metallocenes, certain product attributes may be improved in the ethylene polymer as well as in downstream products (such as films) produced therefrom, as discussed further below with respect to Table III.

TABLE I
Polymerization reaction properties.

| | | | Organo- | | | | Metallocene | Support | Metallocene |
|---|---|---|---|---|---|---|---|---|---|
| Example | Metallocene | Organo- | aluminum | H₂ | 1-hexene (wt. % | Solid | Activity | Activity | Productivity |
| ID | type | aluminum | (mmol) | (ppm) | relative to ethylene) | PE (g) | (g/g/hr) | (g/g/hr) | (g/g) |
| C1 | MET-1 | TIBA | 0.05 | 50 | 15 (initial)/7 (final) | 180.4 | 240533 | 1604 | 180400 |
| C2 | MET-1 | TIBA | 0.10 | 50 | 15 (initial)/7 (final) | 247.5 | 330000 | 2200 | 247500 |
| C3 | MET-1 | TIBA | 0.20 | 50 | 15 (initial)/7 (final) | 258.7 | 344933 | 2300 | 258700 |
| C4 | MET-1 | TIBA | 0.40 | 50 | 15 (initial)/7 (final) | 287.9 | 383867 | 2559 | 287900 |
| 1 | MET-2 | TIBA | 0.10 | 50 | 15 (initial)/7 (final) | 310.9 | 414533 | 2764 | 310900 |
| 2 | MET-2 | TIBA | 0.20 | 50 | 15 (initial)/7 (final) | 389.9 | 519867 | 3466 | 389900 |
| 3 | MET-2 | TIBA | 0.40 | 50 | 15 (initial)/7 (final) | 383.7 | 511600 | 3411 | 383700 |
| 4 | MET-3 | TIBA | 0.05 | 50 | 15 (initial)/7 (final) | 364.4 | 485867 | 3239 | 364400 |
| 5 | MET-3 | TIBA | 0.10 | 50 | 15 (initial)/7 (final) | 391.2 | 521600 | 3477 | 391200 |
| 6 | MET-3 | TIBA | 0.20 | 50 | 15 (initial)/7 (final) | 409.2 | 545600 | 3637 | 409200 |
| 7 | MET-3 | TIBA | 0.40 | 50 | 15 (initial)/7 (final) | 384.2 | 512267 | 3415 | 384200 |
| C5 | MET-1 | TNBA | 0.05 | 50 | 15 (initial)/7 (final) | 96.6 | 128800 | 859 | 96600 |
| C6 | MET-1 | TNBA | 0.10 | 50 | 15 (initial)/7 (final) | 105.6 | 140800 | 939 | 105600 |
| C7 | MET-1 | TNBA | 0.20 | 50 | 15 (initial)/7 (final) | 159.0 | 212000 | 1413 | 159000 |
| C8 | MET-1 | TNBA | 0.40 | 50 | 15 (initial)/7 (final) | 170.7 | 227600 | 1517 | 170700 |
| C9 | MET-1 | TNBA | 1.00 | 50 | 15 (initial)/7 (final) | 203.7 | 271600 | 1811 | 203700 |
| 8 | MET-2 | TNBA | 0.05 | 50 | 15 (initial)/7 (final) | 395.1 | 578195 | 3855 | 395100 |
| 9 | MET-2 | TNBA | 0.20 | 50 | 15 (initial)/7 (final) | 397.7 | 530267 | 3535 | 397700 |
| 10 | MET-2 | TNBA | 0.40 | 50 | 15 (initial)/7 (final) | 432.8 | 633366 | 4222 | 432800 |
| 11 | MET-2 | TNBA | 1.00 | 50 | 15 (initial)/7 (final) | 377.1 | 502800 | 3352 | 377100 |
| C10 | MET-1 | TNOA | 0.60 | 0 | 20 (initial)/0 (final) | 219.0 | 438000 | 2920 | 219000 |
| 12 | MET2 | TNOA | 0.60 | 0 | 20 (initial)/0 (final) | 261.0 | 523746 | 3492 | 261000 |
| C11 | MET-1 | TEA | 0.03 | 50 | 15 (initial)/7 (final) | 132.5 | 176667 | 1178 | 132500 |
| C12 | MET-1 | TEA | 0.10 | 50 | 15 (initial)/7 (final) | 168.9 | 225200 | 1501 | 168900 |
| C13 | MET-1 | TEA | 0.20 | 50 | 15 (initial)/7 (final) | 167.7 | 223600 | 1491 | 167700 |
| C14 | MET-1 | TEA | 0.40 | 50 | 15 (initial)/7 (final) | 98.4 | 131200 | 875 | 98400 |
| 13 | MET-2 | TEA | 0.02 | 50 | 15 (initial)/7 (final) | 103.6 | 138133 | 921 | 103600 |
| 14 | MET-2 | TEA | 0.03 | 50 | 15 (initial)/7 (final) | 304.7 | 406267 | 2708 | 304700 |
| 15 | MET-2 | TEA | 0.07 | 50 | 15 (initial)/7 (final) | 305.3 | 407067 | 2714 | 305300 |
| 16 | MET-2 | TEA | 0.10 | 50 | 15 (initial)/7 (final) | 259.4 | 345867 | 2306 | 259400 |
| 17 | MET-2 | TEA | 0.20 | 50 | 15 (initial)/7 (final) | 211.9 | 282533 | 1884 | 211900 |
| 18 | MET-2 | TEA | 0.40 | 50 | 15 (initial)/7 (final) | 119.0 | 158667 | 1058 | 119000 |
| C15 | MET-1 | TMA | 0.60 | 0 | 20 (initial)/0 (final) | 0.0 | 0 | 0 | 0 |
| C16 | MET-1 | TMA | 0.20 | 0 | 20 (initial)/0 (final) | 29.0 | 29000 | 193 | 29000 |
| C17 | MET-1 | TMA | 0.05 | 0 | 20 (initial)/0 (final) | 125.0 | 125000 | 833 | 125000 |
| 19 | MET-2 | TMA | 0.30 | 0 | 20 (initial)/0 (final) | 22.0 | 22000 | 147 | 22000 |
| 20 | MET-2 | TMA | 0.20 | 0 | 20 (initial)/0 (final) | 67.0 | 67000 | 447 | 67000 |
| 31 | MET-2 | TMA | 0.10 | 0 | 20 (initial)/0 (final) | 149.0 | 149000 | 993 | 149000 |
| 22 | MET-2 | TMA | 0.05 | 0 | 20 (initial)/0 (final) | 295.0 | 590000 | 3933 | 295000 |
| 23 | MET-2 | none | 0.00 | 0 | 20 (initial)/0 (final) | 0.0 | 0 | 0 | 0 |
| 24 | MET-2 | TMA | 0.03 | 0 | 20 (initial)/0 (final) | 183.0 | 183000 | 1220 | 183000 |

TABLE II
Polymer properties.

| | | | Organo- | | | | | | |
|---|---|---|---|---|---|---|---|---|---|
| Example | Metallocene | Organo- | aluminum | | | | | | |
| ID | type | aluminum | (mmol) | Mn/1000 | Mw/1000 | Mz/1000 | Mw/Mn | Mz/Mw | CY-a |
| C1 | MET-1 | TIBA | 0.05 | 46.53 | 113.67 | 220.04 | 2.44 | 1.94 | 0.401 |
| C2 | MET-1 | TIBA | 0.10 | 46.69 | 115.73 | 228.51 | 2.48 | 1.97 | 0.408 |
| C3 | MET-1 | TIBA | 0.20 | 43.29 | 104.23 | 197.65 | 2.41 | 1.90 | 0.436 |
| C4 | MET-1 | TIBA | 0.40 | 37.32 | 100.58 | 205.44 | 2.7 | 2.04 | 0.460 |
| 1 | MET-2 | TIBA | 0.10 | 35.21 | 85.50 | 159.76 | 2.43 | 1.87 | 0.400 |
| 2 | MET-2 | TIBA | 0.20 | 35.13 | 86.90 | 161.7 | 2.47 | 1.86 | 0.565 |
| 3 | MET-2 | TIBA | 0.40 | 43.69 | 122.86 | 260.38 | 2.81 | 2.12 | 0.392 |
| 4 | MET-3 | TIBA | 0.05 | 35.98 | 92.90 | 170.94 | 2.58 | 1.84 | 0.495 |
| 5 | MET-3 | TIBA | 0.10 | 41.13 | 103.49 | 199.2 | 2.52 | 1.92 | 0.451 |
| 6 | MET-3 | TIBA | 0.20 | 37.32 | 105.14 | 213.52 | 2.82 | 2.03 | 0.424 |
| 7 | MET-3 | TIBA | 0.40 | 51.27 | 120.47 | 220.2 | 2.35 | 1.83 | 0.431 |
| C5 | MET-1 | TNBA | 0.05 | 46.34 | 115.44 | 230.14 | 2.49 | 1.99 | 0.312 |
| C6 | MET-1 | TNBA | 0.10 | 79.81 | 203.02 | 443.08 | 2.54 | 2.18 | 0.303 |
| C7 | MET-1 | TNBA | 0.20 | 61.79 | 153.13 | 310.29 | 2.48 | 2.03 | 0.339 |
| C8 | MET-1 | TNBA | 0.40 | 56.83 | 148.26 | 308.01 | 2.61 | 2.08 | 0.356 |
| C9 | MET-1 | TNBA | 1.00 | 75.07 | 180.05 | 338.63 | 2.40 | 1.88 | 0.360 |
| 8 | MET-2 | TNBA | 0.05 | 34.98 | 108.16 | 245.9 | 3.09 | 2.27 | 0.377 |
| 9 | MET-2 | TNBA | 0.20 | 47.77 | 126.16 | 253.37 | 2.64 | 2.01 | 0.380 |
| 10 | MET-2 | TNBA | 0.40 | 36.86 | 121.23 | 265.85 | 3.29 | 2.19 | 0.418 |
| 11 | MET-2 | TNBA | 1.00 | 56.12 | 135.58 | 247.87 | 2.42 | 1.83 | 0.426 |
| C10 | MET-1 | TNOA | 0.60 | 89.38 | 223.05 | 479.1 | 2.50 | 2.15 | 0.399 |
| 12 | MET-2 | TNOA | 0.60 | 77.99 | 191.53 | 373.71 | 2.46 | 1.95 | 0.447 |
| C11 | MET-1 | TEA | 0.03 | 46.55 | 114 | 219.39 | 2.45 | 1.92 | 0.414 |
| C12 | MET-1 | TEA | 0.10 | 46.34 | 116.19 | 228.94 | 2.51 | 1.97 | 0.387 |
| C13 | MET-1 | TEA | 0.20 | 49.54 | 119.8 | 221.61 | 2.42 | 1.85 | 0.406 |
| C14 | MET-1 | TEA | 0.40 | 31.85 | 84.35 | 158.74 | 2.65 | 1.88 | 0.506 |
| 13 | MET-2 | TEA | 0.02 | 44.81 | 110.41 | 203.53 | 2.46 | 1.84 | 0.405 |
| 14 | MET-2 | TEA | 0.03 | 45.85 | 113.37 | 214.09 | 2.47 | 1.89 | 0.400 |
| 15 | MET-2 | TEA | 0.07 | 41.11 | 104.98 | 203.39 | 2.55 | 1.94 | 0.471 |
| 16 | MET-2 | TEA | 0.10 | 46.15 | 111.43 | 207.86 | 2.41 | 1.87 | 0.478 |
| 17 | MET-2 | TEA | 0.20 | 42.51 | 103.31 | 192.97 | 2.43 | 1.87 | 0.436 |
| 18 | MET-2 | TEA | 0.40 | 38.21 | 99.89 | 188.81 | 2.61 | 1.89 | 0.485 |
| C15 | MET-1 | TMA | 0.60 | 51.27 | 120.47 | 220.2 | 2.35 | 1.83 | 0.431 |
| C16 | MET-1 | TMA | 0.20 | NA | NA | NA | NA | NA | NA |
| C17 | MET-1 | TMA | 0.05 | 156.79 | 399.83 | 757.69 | 2.55 | 1.90 | 0.382 |
| 19 | MET-2 | TMA | 0.30 | 119.32 | 289.01 | 552.72 | 2.42 | 1.91 | 0.402 |
| 20 | MET-2 | TMA | 0.20 | 116.22 | 370.89 | 762.04 | 3.19 | 2.05 | 0.284 |
| 21 | MET-2 | TMA | 0.10 | 141.12 | 362.31 | 754.81 | 2.57 | 2.08 | 0.287 |
| 22 | MET-2 | TMA | 0.05 | 112.02 | 300.13 | 659.19 | 2.68 | 2.20 | 0.283 |
| 23 | MET-2 | none | 0.00 | 87.47 | 202.32 | 393.05 | 2.31 | 1.94 | 0.413 |
| 24 | MET-2 | TMA | 0.03 | NA | NA | NA | NA | NA | NA |

### Examples 26-31 and Comparative Examples C18-C19

Examples 26-31 and C18-C19 were conducted on a pilot plant scale, in a 30-gallon (113.6 liter) slurry loop reactor. Pilot-scale polymerizations were carried out under continuous particle form process conditions in a loop reactor (also referred to as a slurry process) by contacting the metallocene solution in isobutane and an organoaluminum solution (TIBA or TNBA), and an activator-support (fluorided silica-coated alumina) in a 1-L stirred autoclave precontactor with continuous output to the loop reactor. The temperature of the stirred autoclave precontactor was maintained at approximately 37.8° C. The organoaluminum and metallocene solution were fed as separate streams into the isobutane flush. The activator-support was flushed with isobutane and the organoaluminum/metallocene mixture flowing together to the autoclave. The isobutane flush used to transport the activator-support into the autoclave was set at a rate that would result in a residence time of approximately 30 minutes in the autoclave (15 minutes in the case of Example 29). The total flow from the autoclave then entered the loop reactor.

Ethylene used was polymerization grade ethylene obtained from AirGas or Linde which was purified through a column of alumina-zeolite adsorbent (activated at 230-290° C. in nitrogen). Polymerization grade 1-hexene (obtained from Chevron Phillips Chemical Company) was purified by distillation and passed through a column of alumina-zeolite absorbent activated at 230-290° C. in nitrogen. The loop reactor was liquid full, 15.2 cm diameter, having a volume of 30 gallons (113.6 liters). Liquid isobutane was used as the diluent. Hydrogen was added in to tune the molecular weight and/or MI of the polymer product. The isobutane was polymerization grade isobutane (obtained from Aeropres) that was further purified by distillation and subsequently passed through a column of alumina (activated at 230-290° C. in nitrogen). Organoaluminum was added in a concentration in a range of 70-85 ppm based on the weight of the diluent in the polymerization reactor.

Reactor conditions included a reactor pressure from 550 psi (3.79 MPa) to 600 psig (4.14 MPa), a mol % ethylene of 9.7 to 10.8% (based on total amount of isobutane, 1-hexene, ethylene, and hydrogen in the reactor), a 1-hexene content of 1.3 to 1.8 mol % (based on total amount of isobutane, 1-hexene, ethylene, and hydrogen in the reactor), and a polymerization temperature of 78.3° C. The reactor was operated to have a residence time of 1 hr. Total metallocene concentrations in the reactor were within a range of 1.2 to 2.4 parts per million (ppm) by weight of the diluent. Total organoaluminum concentrations in the reactor were 69.7 to 83.5 ppm by weight of the diluent. Total activator-support (fluorided silica-coated alumina) concentrations in the reactor were 194.1 to 394.7 ppm by weight of the diluent. Polymer was removed from the reactor at the rate of 56.5 to 57.3 lb/hr (25.6 to 26.0 kg/hr) and passed through a flash chamber and a purge column. Nitrogen was fed to the purge column to ensure the fluff was hydrocarbon free.

Table III summarizes further conditions of the pilot scale polymerization reactions, polymer product characteristics, and resulting film properties. The results shown in Table III confirm the conclusions drawn above regarding the improved metallocene activity for dialkylated metallocene MET-2 relative to non-alkylated metallocenes (e.g., MET-1). Again, polymerizations using MET-2 demonstrated a metallocene activity more than 50% greater than the analogous polymerization using MET-1 (e.g., Example 26 (563,310 g/g/hr) vs. Comparative Example 18 (354,317 g/g/h)). Versatility of dialkylated metallocene compounds in the presence of different organoaluminum compounds was also again confirmed by the pilot plant scale experiments of Examples 26-31. Also as for the bench scale experiments described above, properties of the olefin polymers produced in the pilot plant were also generally similar between the inventive and comparative examples, again with the exception of a marked improvement to the CY-a parameter for examples using dialkylated metallocene MET-2.

All films were prepared on a LabTech 40 mm single screw extruder (30:1 L/D) with a mixing screw containing both a Maddock's mixing element (dispersive mixer) at 22D and a pineapple head mixer (distributive mixer) at the screw tip. The 40 mm extruder had 5 heating zones and the standard heating profile was “flat,” meaning all zones were set to the same temperature at 380° F. (193.3° C.). The extruder was fitted with a weight loss hopper system for gravimetric calculation of extruder output, therefor the output of 18 lb/hr (8.16 kg/hr) was set and achieved by automatically adjusting the screw speed (rpm). For film blown processes, the extruder was fitted with an annular die having a diameter of 100 mm and a die pin for a 1.0 mm die gap. All film samples were produced with a 3:1 blowup ratio and maintained at 1.0 mil (25.4 μm) average thickness across the bubble. The cooling air temperature was set at 13° C. throughout. Frostline height (FLH) was held constant at 6 inches (15.2 cm), and line speed and air speed were varied to maintain FLH and film thickness.

Surprisingly, however, the film produced using these inventive polymers showed significant improvement with respect to haze and Elmendorf tear strength (TD, MD, TD/MD). In particular, Examples 26-27 had a haze of 4.3 and 4.7%, respectively, an amount significantly less than the 6.8% haze of the film produced from the MET-1 catalyzed product of Comparative Example C18. Examples 28-31 using MET-2 and TNBA had an average haze of 3.2%, whereas Comparative Example C19 had a haze of 3.9%. Examples 26-27 using MET-2 and TIBA each had a higher MD Elmendorf tear strength than Example C18 using MTE-1 and TIBA. Examples 28 to 31 using MET-2 and TNBA each had a higher MD Elmendorf tear strength than Example C19 using MET-1 and TNBA

Table III also shows the properties of a commercially produced mLLDPE film for comparison with the inventive examples. As shown, Examples 28-31 particularly demonstrate comparable or improved properties relative to the commercial film, having a haze reduced by 0.5 to 1% while maintaining similar or improved Elmendorf tear strength characteristics.

TABLE III
Pilot plant scale polymerizations, product, and film properties.

| Example ID | C18 | C19 | 26 | 27 | 28 |
|---|---|---|---|---|---|
| Metallocene Type | MET-1 | MET-1 | MET-2 | MET-2 | MET-2 |
| Organoaluminum | TIBA | TNBA | TIBA | TIBA | TNBA |
| Metallocene:organoaluminum | 25 | 25 | 25 | 17 | 25 |
| Hydrogen:ethylene feed ratio (ppmw) | 13.0 | 12.8 | 10.9 | 11.3 | 10.8 |
| Ethylene in reactor (mol %) | 9.7 | 10.8 | 10.2 | 9.8 | 10.5 |
| 1-Hexene in reactor (mol %) | 1.6 | 1.8 | 1.6 | 1.3 | 1.6 |
| Metallocene activity (g/g/hr) | 354317 | 294200 | 563310 | 423207 | 481223 |
| Activator activity (g/g/hr) | 2126 | 1760 | 3333 | 2576 | 2813 |
| HLMI | 18.6 | 18.9 | 19.2 | 23.7 | 16.9 |
| MI | 0.9 | 0.8 | 1.0 | 1.0 | 1.1 |
| Density (g/cc) | 0.9179 | 0.9177 | 0.9184 | 0.9182 | 0.9194 |
| Mn/1000 | 50.32 | 53.70 | 52.25 | 41.29 | 60.41 |
| Mw/1000 | 140.22 | 135.46 | 135.56 | 121.60 | 136.77 |
| Mz/1000 | 317.77 | 273.93 | 275.70 | 242.67 | 240.83 |
| Mw/Mn | 2.8 | 2.5 | 2.6 | 2.9 | 2.3 |
| Mz/Mw | 2.3 | 2.0 | 2.0 | 2.0 | 1.8 |
| CY-a | 0.328 | 0.311 | 0.349 | 0.355 | 0.495 |
| Dart Impact (g) | 1400 | 1400 | 1400 | 1400 | 1400 |
| MD Tear (g) | 118 | 132 | 130 | 125 | 169 |
| TD Tear (g) | 406 | 390 | 397 | 412 | 393 |
| TD/MD | 3.4 | 3.0 | 3.0 | 3.3 | 2.3 |
| Haze (%) | 6.8 | 3.9 | 4.3 | 4.7 | 3.0 |

| Example ID | 29 | 30 | 31 | Commercial |
|---|---|---|---|---|
| Metallocene Type | MET-2 | MET-2 | MET-2 | |
| Organoaluminum | TNBA | TNBA | TNBA | |
| Metallocene:organoaluminum | 17 | 17 | 17 | |
| Hydrogen:ethylene feed ratio (ppmw) | 11.3 | 11.3 | 11.3 | |
| Ethylene in reactor (mol %) | 10.2 | 9.8 | 9.8 | |
| 1-Hexene in reactor (mol %) | 1.4 | 1.3 | 1.3 | |
| Metallocene activity (g/g/hr) | 527475 | 511711 | 478320 | |
| Activator activity (g/g/hr) | 3179 | 2998 | 3588 | |
| HLMI | 18.3 | 17.5 | 18.0 | |
| MI | 1.0 | 1.1 | 1.1 | 1.0 |
| Density (g/cc) | 0.9178 | 0.9179 | 0.9176 | 0.918 |
| Mn/1000 | 59.61 | 60.11 | 60.07 | |
| Mw/1000 | 133.90 | 134.41 | 133.16 | |
| Mz/1000 | 233.60 | 234.54 | 227.84 | |
| Mw/Mn | 2.3 | 2.2 | 2.2 | |
| Mz/Mw | 1.7 | 1.7 | 1.7 | |
| CY-a | 0.536 | 0.544 | 0.568 | |
| Dart Impact (g) | 1400 | 1400 | 1400 | 630 |
| MD Tear (g) | 170 | 206 | 227 | 165 |
| TD Tear (g) | 371 | 335 | 384 | 440 |
| TD/MD | 2.2 | 1.6 | 1.7 | 2.7 |
| Haze (%) | 3.5 | 3.4 | 3.0 | 4.0 |

### Comparative Examples C32-C47 and Examples 48-63

Dual metallocene experiments were conducted using substantially the same procedure as in Examples 1-24 and Comparative Examples C1-C17, except with the conditions listed in Table IV and the following exceptions. Reaction temperature was 95° C. and reaction pressure was 420 psig (2.90 MPa), and the catalyst composition contained 270 mg of a fluorided silica-coated alumina activator-support, 1 mmol of TIBA, and the metallocene compounds shown below (Me is methyl, Ph is phenyl, and t-Bu is tert-butyl). Comparative Examples C32-C47 utilized MTE-4 (0.6 mg) and MTE-6 (1.2 mg), while Inventive Examples 48-63 utilized “dimethyl metallocene” MTE-5 (0.55 mg) and MTE-6 (1.2 mg).

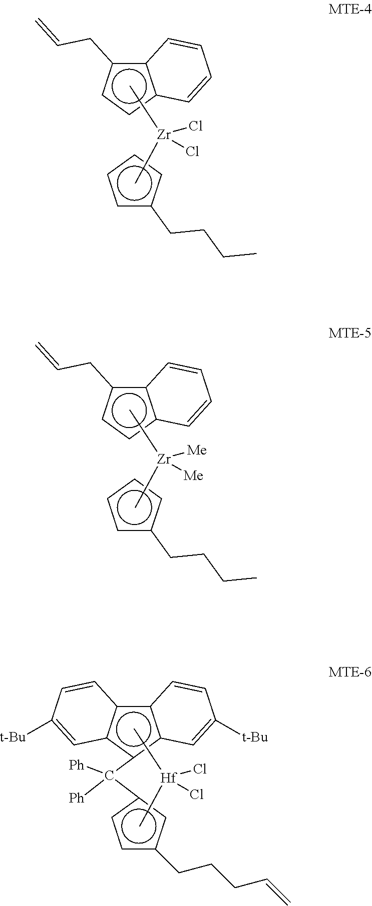

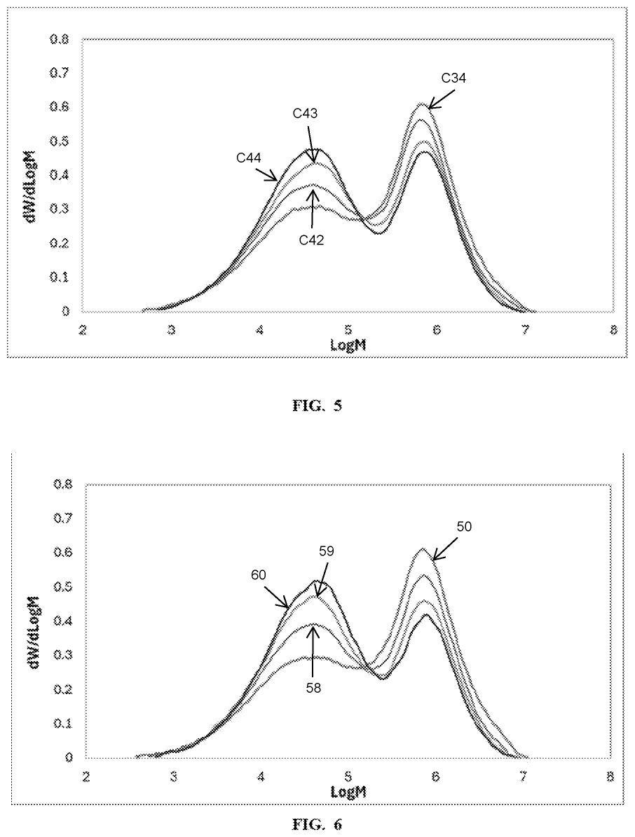

Table IV summarizes the polymerization conditions for Comparative Examples C32-C47 and Examples 48-63, and Table V summarizes the polymer product characteristics for Comparative Examples C32-C47 and Examples 48-63. FIGS. 5-6 illustrate the molecular weight distributions (amount of polymer versus the logarithm of molecular weight) of the polymers of Comparative Examples C34 and C42-C44 and Examples 50 and 58-60, respectively.

From the results presented in Table IV and FIGS. 5-6, the catalyst systems with the dihydrocarbyl metallocene compounds had comparable productivity and activity to that of the comparative examples. Similarly, polymers produced from the dialkylated metallocene catalyst systems had properties very similar to the polymers produced in the comparative examples. Generally, Mn, Mw, Mz, Mw/Mn, and Mz/Mw for the inventive examples remained within 20% of those values for the analogous comparative examples under identical conditions. In several instances, the differences in the polymer properties between the inventive and comparative examples were much less than 20%, e.g., within 15%, within 10%, within 5%, or within 3%. Thus, the benefits in solubility of the dihydrocarbyl metallocene compounds are achieved without any significant changes in catalyst productivity/activity and polymer properties.

### Examples 70-75 and Comparative Examples C64-C69

Solubility testing of unbridged “dimethyl” metallocene MTE-5 and unbridged comparative metallocene MTE-4 in heptane and in 1-hexene is summarized in Table VI. The listed amounts of the respective metallocene compound and solvent were mixed at different temperatures and visually observed after mixing, and some after storage at a particular temperature for 2 days to 3 weeks. It should be noted that MTE-4 is a solid at room temperature (23° C.), while MTE-5 is a thick oil at room temperature and a waxy solid at 0° C.

Referring first to Comparative Examples C64-C69, the room temperature (23° C.) solubility limit of MTE-4 in 1-hexene was less than 0.15 wt. %, and likely around 0.1 wt. %. In contrast, and unexpectedly, the room temperature (23° C.) solubility limit of MTE-5 in 1-hexene was over 50 wt. %, as shown by Examples 72-74 (40-80 wt. % solutions). The room temperature (23° C.) solubility limit of MTE-5 in heptane was also surprisingly over 50 wt. %, as shown by Examples 70-71 and 75 (40-80 wt. % solutions). Even more importantly, the solubility was maintained at sub-ambient temperatures of 0° C. to −15° C. for time periods of 2 days to 3 weeks at MTE-5 loadings of over 50 wt. % in 1-hexene (Example 74) and over 50 wt. % in heptane (Example 75).

### Comparative Examples C76-C77 and Examples 78-81

Polymerization experiments using a single metallocene compound were conducted using substantially the same procedure as in Examples 1-24 and Comparative Examples C1-C17, except that the reaction temperature was 90° C. and reaction pressure was 390 psig (2.69 MPa), and the catalyst composition contained 4.5 μmol of the metallocene compound, 200 mg of a fluorided silica-coated alumina activator-support, and 0.8 mmol of TIBA. The metallocene compounds are shown below (Me is methyl and Ph is phenyl).

From the results summarized in Table VII, the catalyst systems with the dihydrocarbyl metallocene compounds had comparable or superior productivity and activity to that of the comparative examples, as well as comparable 1-hexene incorporation.

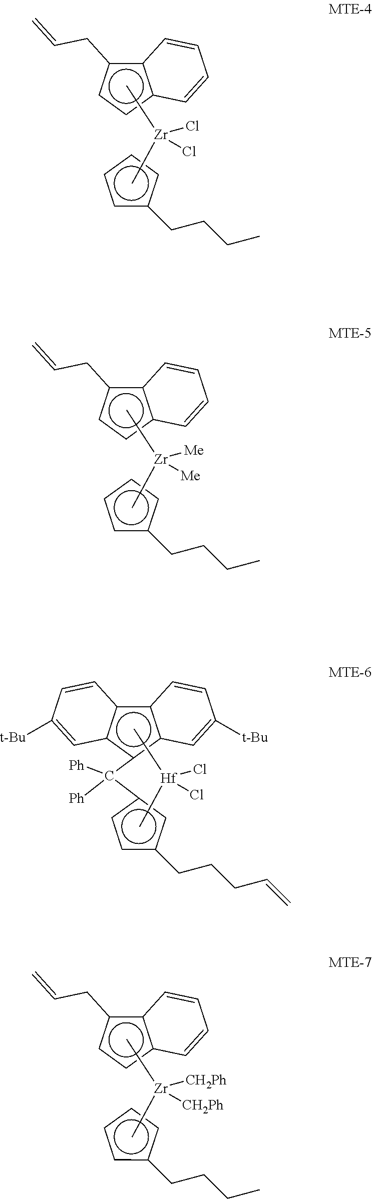

TABLE IV
Polymerization conditions.

| | | | | | Catalyst | Catalyst | Support |
|---|---|---|---|---|---|---|---|
| | Run Time | H2 (ppm, | 1-Hexene | Solid PE | Productivity | Activity | Activity |
| Example | (min) | in C2) | (g) | (g) | (g/g) | (g/g/hr) | (g/g/hr) |
| C32 | 47.2 | 0 | 0.0 | 249 | 138333 | 175847 | 1172 |
| C33 | 50.9 | 100 | 0.0 | 246 | 136667 | 161100 | 1074 |
| C34 | 56.3 | 150 | 0.0 | 245 | 136111 | 145056 | 967 |
| C35 | 58.4 | 200 | 0.0 | 248 | 137778 | 141553 | 944 |
| C36 | 38.2 | 0 | 6.0 | 254 | 141111 | 221640 | 1478 |
| C37 | 38.1 | 0 | 11.0 | 256 | 142222 | 223972 | 1493 |
| C38 | 31.9 | 0 | 15.5 | 256 | 142222 | 267503 | 1783 |
| C39 | 59.9 | 100 | 6.5 | 252 | 140000 | 140234 | 935 |
| C40 | 55.2 | 100 | 11.0 | 250 | 138889 | 150966 | 1006 |
| C41 | 46.9 | 100 | 15.0 | 252 | 140000 | 179104 | 1194 |
| C42 | 59.8 | 150 | 6.5 | 253 | 140556 | 141026 | 940 |
| C43 | 57.6 | 150 | 11.5 | 258 | 143333 | 149306 | 995 |
| C44 | 51.8 | 150 | 15.5 | 259 | 143889 | 166667 | 1111 |
| C45 | 58.3 | 200 | 6.5 | 255 | 141667 | 145798 | 972 |
| C46 | 51.4 | 200 | 10.5 | 251 | 139444 | 162776 | 1085 |
| C47 | 54.1 | 200 | 16.0 | 259 | 143889 | 159581 | 1064 |
| 48 | 55.5 | 0 | 0.0 | 263 | 150286 | 162471 | 1053 |
| 49 | 61.2 | 100 | 0.0 | 263 | 150286 | 147339 | 955 |
| 50 | 68.1 | 150 | 0.0 | 265 | 151429 | 133417 | 865 |
| 51 | 64.4 | 200 | 0.0 | 253 | 144571 | 134694 | 873 |
| 52 | 44.8 | 0 | 7.0 | 263 | 150286 | 201276 | 1305 |
| 53 | 42.2 | 0 | 12.0 | 260 | 148571 | 211239 | 1369 |
| 54 | 39.1 | 0 | 15.5 | 263 | 150286 | 230617 | 1495 |
| 55 | 73.1 | 100 | 7.5 | 258 | 147429 | 121008 | 784 |
| 56 | 62.6 | 100 | 11.0 | 255 | 145714 | 139662 | 905 |
| 57 | 57.2 | 100 | 15.0 | 259 | 148000 | 155245 | 1006 |
| 58 | 67.5 | 150 | 6.5 | 251 | 143429 | 127492 | 826 |
| 59 | 59.9 | 150 | 10.5 | 251 | 143429 | 143668 | 931 |
| 60 | 48.9 | 150 | 16.0 | 246 | 140571 | 172480 | 1118 |
| 61 | 68.0 | 200 | 6.5 | 256 | 146286 | 129076 | 837 |
| 62 | 59.9 | 200 | 10.5 | 254 | 145143 | 145385 | 942 |
| 63 | 59.7 | 200 | 15.5 | 256 | 146286 | 147021 | 953 |

TABLE V
Polymer properties (molecular weights in g/mol).

| | Density | Mn/ | Mw/ | Mz/ | | |
|---|---|---|---|---|---|---|
| Example | (g/cc) | 1000 | 1000 | 1000 | Mw/Mn | Mz/Mw |
| C32 | 0.938 | 91.8 | 1327 | 4233 | 14.5 | 3.2 |
| C33 | 0.944 | 58.4 | 1009 | 3703 | 17.3 | 3.7 |
| C34 | 0.949 | 24.3 | 657 | 2452 | 27.0 | 3.7 |
| C35 | 0.948 | 14.7 | 425 | 1250 | 28.9 | 2.9 |
| C36 | 0.937 | 84.0 | 912 | 3410 | 10.9 | 3.7 |
| C37 | 0.933 | 79.3 | 783 | 3084 | 9.9 | 3.9 |
| C38 | 0.930 | 76.3 | 666 | 2874 | 8.7 | 4.3 |
| C39 | 0.939 | 24.8 | 753 | 3127 | 30.3 | 4.2 |
| C40 | 0.936 | 33.0 | 659 | 2887 | 20.0 | 4.4 |
| C41 | 0.933 | 30.9 | 540 | 2473 | 17.5 | 4.6 |
| C42 | 0.939 | 24.2 | 548 | 2149 | 22.7 | 3.9 |
| C43 | 0.939 | 22.5 | 476 | 1828 | 21.1 | 3.8 |
| C44 | 0.936 | 22.8 | 441 | 1779 | 19.4 | 4.0 |
| C45 | 0.944 | 17.4 | 389 | 1262 | 22.4 | 3.2 |
| C46 | 0.940 | 14.5 | 363 | 1244 | 25.1 | 3.4 |
| C47 | 0.937 | 16.0 | 372 | 1448 | 23.3 | 3.9 |
| 48 | 0.940 | 64.2 | 1121 | 3530 | 17.5 | 3.2 |
| 49 | 0.942 | 42.3 | 975 | 3500 | 23.1 | 3.6 |
| 50 | 0.945 | 22.6 | 676 | 2379 | 29.9 | 3.5 |
| 51 | 0.948 | 14.4 | 427 | 1201 | 29.7 | 2.8 |
| 52 | 0.932 | 75.9 | 911 | 3175 | 12.0 | 3.5 |
| 53 | 0.932 | 72.1 | 754 | 2941 | 10.5 | 3.9 |
| 54 | 0.929 | 73.3 | 661 | 2687 | 9.0 | 4.1 |
| 55 | 0.939 | 30.8 | 782 | 2941 | 25.4 | 3.8 |
| 56 | 0.933 | 30.6 | 666 | 2738 | 21.8 | 4.1 |
| 57 | 0.933 | 31.3 | 578 | 2385 | 18.5 | 4.1 |
| 58 | 0.941 | 20.3 | 518 | 1860 | 25.5 | 3.6 |
| 59 | 0.939 | 21.2 | 443 | 1759 | 20.9 | 4.0 |
| 60 | 0.937 | 21.4 | 400 | 1699 | 18.8 | 4.2 |
| 61 | 0.941 | 10.2 | 370 | 1189 | 36.4 | 3.2 |
| 62 | 0.940 | 12.6 | 357 | 1198 | 28.2 | 3.4 |
| 63 | 0.938 | 13.6 | 351 | 1247 | 25.9 | 3.5 |

TABLE VI
Solubility comparison.

| | | | | | | |
|---|---|---|---|---|---|---|
| Example | 70 | 71 | 72 | 73 | 74 | 75 |

| | | | | | | | |
|---|---|---|---|---|---|---|---|
| MTE-5 | g | 5 | 5 | 5 | 5 | 0.82 | 0.82 |
| Heptane | mL | 2 | 10 | NA | NA | NA | 1 |
| 1-Hexene | mL | NA | NA | 2 | 10 | 1 | NA |
| [MTE-5] | wt % | 78.5 | 42.2 | 78.8 | 42.6 | 54.9 | 54.5 |

| | | | | | | | | |
|---|---|---|---|---|---|---|---|---|
| Visual observation | 23 | C. | miscible | miscible | miscible | miscible | miscible | miscible |
| 2 days | 0 | C. | NA | NA | NA | NA | miscible | miscible |
| 3 days | −5° | C. | NA | NA | NA | NA | miscible | miscible |
| 3 weeks | −15° | C. | NA | NA | NA | NA | miscible | miscible |

| Example | | C64 | C65 | C66 | C67 | C68 | C69 |
|---|---|---|---|---|---|---|---|
| MTE-4 | mg | 26.9 | 27.1 | 26.9 | 27.1 | 5.5 | 19.2 |
| Heptane | mL | NA | NA | NA | NA | NA | NA |
| 1-Hexene | mL | 20 | 20 | 30 | 30 | 30 | 30 |
| [MTE-4] | wt % | 0.199 | 0.201 | 0.133 | 0.134 | 0.027 | 0.095 |
| Visual observation | 23 C. | not | not | pale yellow, | pale yellow, | completely | completely |
| | | completely | completely | slightly | slightly | dissolved | dissolved |
| | | dissolved | dissolved | cloudy | cloudy | | |

TABLE VII

| | | | Solid | Hexene in | Metallocene | Metallocene | Support |
|---|---|---|---|---|---|---|---|
| | | 1-Hexene | PE | PE (wt %) | Activity | Activity | Activity |
| Example | Metallocene | (g) | (g) | (NMR) | (g/g/hr) | (g/mmol/hr) | (g/g/hr) |
| C76 | MTE-4 | 15.2 | 185.0 | 0.35% | 245575 | 107567 | 2456 |
| C77 | MTE-4 | 29.5 | 184.0 | 0.76% | 254378 | 111423 | 2544 |
| 78 | MTE-5 | 15.4 | 184.0 | 0.35% | 219048 | 86958 | 1971 |
| 79 | MTE-5 | 29.9 | 182.0 | 0.76% | 242667 | 96335 | 2184 |
| 80 | MTE-7 | 15.6 | 187.5 | 0.36% | 592105 | 325333 | 2961 |
| 81 | MTE-7 | 29.8 | 189.5 | 0.83% | 631667 | 347070 | 3158 |

### Aspects

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):
Aspect 1. A catalyst composition comprising:
an organoaluminum compound;
an activator; and
a metallocene solution comprising:
   an aliphatic hydrocarbon solvent; and
   an amount of a metallocene compound having Formula (I) in a range from 0.1 wt. % to 5 wt. % of the metallocene solution:

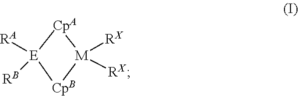

wherein:
M is Zr, Ti, or Hf;
Cp^{A} and Cp^{B} independently are a substituted or unsubstituted cyclopentadienyl group, a substituted or unsubstituted indenyl group, or a substituted or unsubstituted fluorenyl group;
E is C, Si, Ge, or B;
each R^{X} is a C1 to C18 hydrocarbyl group; and
R^{A} and R^{B} independently are H, a C₁ to C₃₆ hydrocarbyl group, a C₁ to C₃₆ hydrocarboxy group, or a C₁ to C₃₆ hydrocarbylsilyl group.
Aspect 2. The catalyst composition defined in aspect 1, wherein M is Zr.
Aspect 3. The catalyst composition defined in aspect 1 or 2, wherein Cp^{A} is a substituted fluorenyl group.
Aspect 4. The catalyst composition defined in any one of aspects 1-3, wherein Cp^{B} is an unsubstituted cyclopentadienyl group.
Aspect 5. The catalyst composition defined in any one of aspects 1-4, wherein E is C.
Aspect 6. The catalyst composition defined in any one of aspects 1-5, wherein at least one of R^{A} and R^{B} is a phenyl group.
Aspect 7. The catalyst composition defined in any one of aspects 1-6, wherein at least one of R^{A} and R^{B} is an alkyl group (e.g., a C₁ to C₈ alkyl group).
Aspect 8. The catalyst composition defined in any one of aspects 1-7, wherein at least one of R^{A} and R^{B} is an alkenyl group (e.g., a C₃ to C₈ terminal alkenyl group).
Aspect 9. The catalyst composition defined in any one of aspects 1-8, wherein one of R^{A} and R^{B} is a methyl group and the other of R^{A} and R^{B} is an alkenyl group.
Aspect 10. The catalyst composition defined in any one of aspects 1-9, wherein the metallocene compound has the formula:

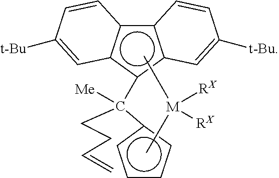

Aspect 11. The catalyst composition defined in any one of aspects 1-10, wherein each R^{X} is a C₁ to C₈ hydrocarbyl group.
Aspect 12. The catalyst composition defined in any one of aspects 1-11, wherein each R^{X} is a methyl group, a phenyl group, or a benzyl group.
Aspect 13. The catalyst composition defined in any one of aspects 1-12, wherein each R^{X} is a phenyl group.
Aspect 14. The catalyst composition defined in any one of aspects 1-12, wherein each R^{X} is a methyl group.
Aspect 15. The catalyst composition defined in any one of aspects 1-12, wherein each R^{X} is a benzyl group.
Aspect 16. The catalyst composition defined in any one of aspects 1-15, wherein an amount of the metallocene compound is in any range disclosed herein (e.g., from 0.5 wt. % to 5 wt. %, from 1 wt. % to 4 wt. %, or from 2 wt. % to 4 wt. % of the metallocene solution).
Aspect 17. The catalyst composition defined in any one of aspects 1-16, wherein the aliphatic hydrocarbon solvent comprises a C₃ to C₁₆ alkane (e.g., paraffins, isoparaffins), or a C₄-C₈ alkane (e.g., isobutane, heptane).
Aspect 18. The catalyst composition defined in any one of aspects 1-17, wherein an amount of the aliphatic hydrocarbon solvent is at least 85 wt. %, or at least 95 wt. %; or alternatively, in a range from 95 wt. % to 99.9 wt. %, based on the weight of the metallocene solution.
Aspect 19. The catalyst composition defined in any one of aspects 1-18, wherein the metallocene solution does not comprise an aromatic compound (e.g., toluene).
Aspect 20. The catalyst composition defined in any one of aspects 1-19, wherein the metallocene solution does not comprise an olefin (e.g., 1-hexene).
Aspect 21. The catalyst composition defined in any one of aspects 1-20, wherein the metallocene solution consists of the aliphatic hydrocarbon solvent and the metallocene compound.
Aspect 22. The catalyst composition defined in any one of aspects 1-21, wherein a solubility of the metallocene compound in the aliphatic hydrocarbon solvent (e.g., heptane) at 25° C. is in a range from 0.2 wt. % to 8 wt. %, from 0.5 wt. % to 5 wt. %, or from 1 wt. % to 4 wt. %.
Aspect 23. The catalyst composition defined in any one of aspects 1-22, wherein the activator comprises an activator-support, an aluminoxane compound, an organoboron or organoborate compound, an ionizing ionic compound, or any combination thereof.
Aspect 24. The catalyst composition defined in any one of aspects 1-23, wherein the activator comprises an activator-support, the activator-support comprising any solid oxide treated with any electron-withdrawing anion disclosed herein.
Aspect 25. The catalyst composition defined in aspect 24, wherein the activator-support comprises fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof.
Aspect 26. The catalyst composition defined in aspect 24, wherein the activator-support comprises fluorided alumina, sulfated alumina, fluorided silica-alumina, sulfated silica-alumina, fluorided silica-coated alumina, fluorided-chlorided silica-coated alumina, sulfated silica-coated alumina, or any combination thereof.
Aspect 27. The catalyst composition defined in aspect 24, wherein the activator-support comprises a fluorided solid oxide and/or a sulfated solid oxide.
Aspect 28. The catalyst composition defined in aspect 24, wherein the activator-support comprises fluorided silica-coated alumina, sulfated alumina, or a combination thereof.
Aspect 29. The catalyst composition defined in any one of aspects 24-28, wherein the activator further comprises any metal or metal ion disclosed herein, e.g., zinc, nickel, vanadium, titanium, silver, copper, gallium, tin, tungsten, molybdenum, zirconium, or any combination thereof.
Aspect 30. The catalyst composition defined in any one of aspects 1-29, wherein the organoaluminum compound is an alkylaluminum.
Aspect 31. The catalyst composition defined in aspect 30, wherein the alkylaluminum comprises trimethylaluminum (TMA), triethylaluminum (TEA), tri-n-propylaluminum (TNPA), tri-n-butylaluminum (TNBA), triisobutylaluminum (TIBA), tri-n-hexylaluminum, tri-n-octylaluminum (TNOA), or combinations thereof.
Aspect 32. The catalyst composition defined in aspect 30, wherein the alkylaluminum comprises triethylaluminum (TEA), tri-n-butylaluminum (TNBA), triisobutylaluminum (TIBA), or a combination thereof.
Aspect 33. The catalyst composition defined in any one of aspects 1-32, wherein each R^{X} is a methyl group, each R^{X} is a phenyl group, or each R^{X} is a benzyl group; and wherein the organoaluminum compound comprises trimethylaluminum (TMA), triethylaluminum (TEA), tri-n-butylaluminum (TNBA), triisobutylaluminum (TIBA), or a combination thereof.
Aspect 34. The catalyst composition defined in any one of aspects 24-33, wherein the catalyst composition is substantially free of aluminoxane compounds, organoboron or organoborate compounds, ionizing ionic compounds, or combinations thereof.
Aspect 35. The catalyst composition defined in any one of aspects 24-33, further comprising an aluminoxane compound, an organoboron or organoborate compound, an ionizing ionic compound, an organoaluminum compound, an organozinc compound, an organomagnesium compound, an organolithium compound, or any combination thereof.
Aspect 36. The catalyst composition defined in any one of aspects 1-35, wherein a metallocene activity of the catalyst composition is in any range disclosed herein, e.g., greater than 275,000 grams, greater than 350,000 grams, greater than 400,000 grams, greater than 500,000 grams, etc., of ethylene polymer per gram of metallocene compound per hour, under slurry polymerization conditions, with a trialkylaluminum as the organoaluminum compound and fluorided silica-coated alumina, using isobutane as a diluent, at a polymerization temperature of 80° C. and a reactor pressure of 270 psig (or 320 psig (1.86 MPa or 2.21 MPa)).
Aspect 37. A polymerization process comprising contacting the catalyst composition defined in any one of aspects 1-36 with an olefin monomer and an optional olefin comonomer in a polymerization reactor system under polymerization conditions to produce an olefin polymer.
Aspect 38. The process defined in aspect 37, wherein the olefin monomer comprises any olefin monomer disclosed herein, e.g., any C₂-C₂₀ olefin.
Aspect 39. The process defined in aspect 37 or 38, wherein the olefin monomer and the optional olefin comonomer independently comprise a C₂-C₂₀ alpha-olefin.
Aspect 40. The process defined in any one of aspects 37-39, wherein the olefin monomer comprises ethylene.
Aspect 41. The process defined in any one of aspects 37-40, wherein the catalyst composition is contacted with ethylene and an olefin comonomer comprising a C₃-C₁₀ alpha-olefin.
Aspect 42. The process defined in aspect 41, wherein the C₃-C₁₀ alpha-olefin is 1-butene, 1-hexene, 1-octene, or a mixture thereof.
Aspect 43. The process defined in any one of aspects 37-42, wherein the polymerization reactor system comprises a slurry reactor, a gas-phase reactor, a solution reactor, a multizone circulating reactor, or a combination thereof; alternatively, a loop slurry reactor; or alternatively, a fluidized bed reactor.
Aspect 44. The process defined in any one of aspects 37-43, wherein the polymerization reactor system comprises one reactor, two reactors, or two or more reactors.
Aspect 45. The process defined in any one of aspects 37-44, wherein the olefin polymer comprises any olefin polymer disclosed herein.
Aspect 46. The process defined in any one of aspects 37-45, wherein the olefin polymer comprises an ethylene homopolymer, an ethylene/1-butene copolymer, an ethylene/1-hexene copolymer, and/or an ethylene/1-octene copolymer.
Aspect 47. The process defined in any one of aspects 37-46, wherein the olefin polymer comprises an ethylene/1-hexene copolymer.
Aspect 48. The process defined in any one of aspects 37-47, wherein the polymerization conditions comprise a polymerization reaction temperature in a range from 60° C. to 280° C. and a reaction pressure in a range from 200 to 1000 psig (1.38 to 6.90 MPa).
Aspect 49. The process defined in any one of aspects 37-48, wherein the polymerization conditions are substantially constant, e.g., for a particular polymer grade.
Aspect 50. The process defined in any one of aspects 37-49, wherein no hydrogen is added to the polymerization reactor system.
Aspect 51. The process defined in any one of aspects 37-49, wherein hydrogen is added to the polymerization reactor system.
Aspect 52. The process defined in any one of aspects 37-51, wherein an amount of the metallocene compound in the polymerization reactor system is in a range from 0.1 ppmw to 10 ppmw, based on diluent.
Aspect 53. The process defined in any one of aspects 37-52, wherein an amount of the organoaluminum compound in the polymerization reactor system is in a range from 10 ppmw to 5,000 ppmw, based on diluent.
Aspect 54. The process defined in any one of aspects 37-53, wherein an amount of the activator (e.g., activator-support) in the polymerization reactor system is in a range from 50 ppmw to 2,500 ppmw, based on diluent.
Aspect 55. The process defined in any one of aspects 37-54, further comprising contacting the catalyst composition, the olefin monomer and the optional olefin comonomer with a second organoaluminum compound (e.g., by feeding the second organoaluminum compound into the polymerization reactor system through a split feed line with the catalyst composition, by feeding the second organoaluminum compound directly into the polymerization reactor system, etc.).
Aspect 56. The process defined in aspect 55, wherein the second organoaluminum compound is the same as the organoaluminum compound in the catalyst composition.
Aspect 57. An olefin polymer produced by the process defined in any one of aspects 37-56.
Aspect 58. The polymer defined in aspect 57, wherein the olefin polymer comprises an ethylene homopolymer and/or an ethylene/α-olefin copolymer.
Aspect 59. The polymer defined in aspect 57 or 58, wherein the olefin polymer comprises an ethylene homopolymer, an ethylene/1-butene copolymer, an ethylene/1-hexene copolymer, and/or an ethylene/1-octene copolymer.
Aspect 60. The polymer defined in any one of aspects 57-59, wherein the olefin polymer comprises an ethylene/1-hexene copolymer.
Aspect 61. The polymer defined in any one of aspects 57-60, wherein the olefin polymer has a CY-a parameter at 190° C. in any range disclosed herein, e.g., from 0.2 to 0.6, from 0.25 to 0.6, from 0.3 to 0.6, from 0.4 to 0.6, from 0.5 to 0.6, etc.
Aspect 62. The polymer defined in any one of aspects 57-61, wherein the olefin polymer has a melt index (MI) in any range disclosed herein, e.g., from 0.01 to 10 g/10 min, from 0.1 to 5 g/10 min, from 0.4 to 4 g/10 min, from 0.75 to 2.75 g/10 min, etc.
Aspect 63. The polymer defined in any one of aspects 57-62, wherein the olefin polymer has a high load melt index (HLMI) in any range disclosed herein, e.g., from 0.1 to 100 g/10 min, from 1 to 50 g/10 min, from 5 to 25 g/10 min, etc.
Aspect 64. The polymer defined in any one of aspects 57-63, wherein the olefin polymer has a ratio of HLMI/MI in any range disclosed herein, e.g., from 10 to 100, from 15 to 75, from 15 to 50, from 15 to 35, from 15 to 25, etc.
Aspect 65. The polymer defined in any one of aspects 57-64, wherein the olefin polymer has a ratio of Mw/Mn in any range disclosed herein, e.g., from 2 to 40, from 2.2 to 30, from 2.2 to 5, from 10 to 35, etc.
Aspect 66. The polymer defined in any one of aspects 57-65, wherein the olefin polymer has a ratio of Mz/Mw in any range disclosed herein, e.g., from 1.5 to 5, from 1.6 to 4, from 1.7 to 3.5, etc.
Aspect 67. The polymer defined in any one of aspects 57-66, wherein the olefin polymer has a Mz in any range disclosed herein, e.g., from 100,000 to 5,000,000 g/mol, from 150,000 to 3,000,000 g/mol, from 200,000 to 2,500,000 g/mol, etc.
Aspect 68. The polymer defined in any one of aspects 57-67, wherein the olefin polymer has a Mw in any range disclosed herein, e.g., from 50,000 to 1,800,000, from 85,000 to 1,200,000, from 85,000 to 1,000,000, from 120,000 to 800,000 g/mol, etc.
Aspect 69. The polymer defined in any one of aspects 57-68, wherein the olefin polymer has a Mn in any range disclosed herein, e.g., from 10,000 to 200,000 g/mol, from 15,000 to 150,000 g/mol, from 15,000 to 100,000 g/mol, from 20,000 to 80,000 g/mol, etc.
Aspect 70. An article of manufacture comprising (or produced from) the olefin polymer defined in any one of aspects 57-69 (e.g., an agricultural film, an automobile part, a bottle, a container for chemicals, a drum, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier).
Aspect 71. A film comprising (or produced from) the olefin polymer defined in any one of aspects 57-69.
Aspect 72. The film defined in aspect 71, wherein the film has a haze (with or without additives) in any range disclosed herein, e.g., less than or equal to 10%, less than or equal to 9%, from 2 to 6%, from 2 to 5%, from 3 to 4%, etc.
Aspect 73. The film defined in aspect 71 or 72, wherein the film has a MD Elmendorf tear strength in any range disclosed herein, e.g., from 100 to 350 g/mil (3.94 to 13.78 g/μm), from 125 to 325 g/mil (4.92 to 12.80 g/μm), from 150 to 300 g/mil (5.91 to 11.81 g/μm), etc.
Aspect 74. The film defined in any one of aspects 71-73, wherein the film has a TD Elmendorf tear strength in any range disclosed herein, e.g., from 150 to 600 g/mil (5.91 to 23.62 g/μm), from 225 to 550 g/mil (8.86 to 21.65 g/μm), from 300 to 450 g/mil (11.81 to 17.72 g/μm), etc.
Aspect 75. The film defined in any one of aspects 71-74, wherein the film has a ratio of TD Elmendorf tear strength to MD Elmendorf tear strength (TD:MD) in any range disclosed herein, e.g., from 1:1 to 10:1, from 1:1 to 5:1, from 2:1 to 5:1, from 2.5:1 to 4:1, etc.

What is claimed is:

1. A process to produce a catalyst composition, the process comprising:
(i) providing a metallocene solution comprising from 10 to 70 wt. % of a dihydrocarbyl metallocene compound in a first aliphatic hydrocarbon solvent;
(ii) adding an amount of a second aliphatic hydrocarbon solvent to the metallocene solution to form a dilute solution comprising from 0.1 to 10 wt. % of the dihydrocarbyl metallocene compound; and
(iii) contacting, in any order, the dilute solution, an activator-support, and an organoaluminum compound to form the catalyst composition.

2. The process of claim 1, wherein the first aliphatic hydrocarbon solvent and the second aliphatic hydrocarbon solvent independently comprise a linear or branched C₄-C₈ alkane.

3. The process of claim 1, wherein the first aliphatic hydrocarbon solvent and the second aliphatic hydrocarbon solvent independently comprise a linear C₄-C₁₂ α-olefin.

4. The process of claim 1, wherein:
the metallocene solution comprises from 20 to 50 wt. % of the dihydrocarbyl metallocene compound;
the dilute solution comprises from 0.5 to 5 wt. % of the dihydrocarbyl metallocene compound;
the metallocene solution and the dilute solution contain less than 1 wt. % of an aromatic solvent;
the metallocene solution comprises at least 98 wt. % of the dihydrocarbyl metallocene compound and the first aliphatic hydrocarbon solvent; or
any combination thereof.

5. The process of claim 1, wherein a ratio of an amount of the dihydrocarbyl metallocene compound, in weight percent, in the metallocene solution to the dilute solution is from 2:1 to 500:1.

6. The process of claim 1, wherein:
step (i) is conducted at a temperature from −15° C. to 60° C.;
step (ii) is conducted at a temperature from −15° C. to 60° C.;
step (iii) is conducted at a temperature from −15° C. to 60° C.; or
any combination thereof.

7. The process of claim 1, wherein step (iii) comprises:
(a) contacting the activator-support and the organoaluminum compound to form a pre-contacted mixture; and
(b) contacting the pre-contacted mixture with the dilute solution to form the catalyst composition.

8. The process of claim 1, wherein in step (iii):
the dilute solution and the organoaluminum compound are contacted, in any order, with a slurry of the activator-support in a diluent; and/or
the dilute solution and the activator-support are contacted, in any order, with a co-catalyst solution of the organoaluminum compound in a hydrocarbon solvent.

9. The process of claim 1, wherein the activator-support comprises:
a fluorided solid oxide and/or a sulfated solid oxide; or
fluorided silica-alumina, fluorided silica-coated alumina, sulfated alumina, or a combination thereof.

10. The process of claim 1, wherein:
the organoaluminum compound comprises trimethylaluminum (TMA), triethylaluminum (TEA), tri-n-propylaluminum (TNPA), tri-n-butylaluminum (TNBA), triisobutylaluminum (TIBA), tri-n-hexylaluminum, tri-n-octylaluminum (TNOA), or a combination thereof; and/or
the catalyst composition is substantially free of aluminoxane compounds, organoboron or organoborate compounds, ionizing ionic compounds, or combinations thereof.

11. The process of claim 1, wherein the dihydrocarbyl metallocene compound comprises:
a bridged zirconium or hafnium based metallocene compound with a cyclopentadienyl group and a fluorenyl group;
an unbridged zirconium or hafnium based metallocene compound containing two cyclopentadienyl groups, two indenyl groups, or a cyclopentadienyl and an indenyl group;
an unbridged zirconium based metallocene compound containing a cyclopentadienyl group and an indenyl group; or
any combination thereof.

12. The process of claim 1, wherein the dihydrocarbyl metallocene compound comprises a bridged metallocene compound and an unbridged metallocene compound.

13. The process of claim 1, wherein the dihydrocarbyl metallocene compound comprises:
two hydrocarbyl substituents independently selected from a C₁ to C₁₈ hydrocarbyl group;
two hydrocarbyl substituents independently selected from a methyl group, a phenyl group, and/or a benzyl group;
two methyl group substituents;
two phenyl group substituents; or
two benzyl group substituents.

14. The catalyst composition prepared by the process of claim 1.

15. A polymerization process comprising:
performing the process to produce the catalyst composition of claim 1, and contacting the catalyst composition with an olefin monomer and an optional olefin comonomer in a polymerization reactor system under polymerization conditions to produce an olefin polymer; or
contacting the catalyst composition of claim 14 with an olefin monomer and an optional olefin comonomer in a polymerization reactor system under polymerization conditions to produce an olefin polymer.

16. The polymerization process of claim 15, wherein the olefin monomer comprises ethylene.

17. The polymerization process of claim 15, wherein the olefin comonomer is present and the olefin comonomer comprises 1-butene, 1-hexene, 1-octene, or a mixture thereof.

18. The polymerization process of claim 15, wherein the olefin polymer comprises an ethylene homopolymer, an ethylene/1-butene copolymer, an ethylene/1-hexene copolymer, and/or an ethylene/1-octene copolymer.

19. The polymerization process of claim 15, wherein the polymerization reactor system comprises a loop slurry reactor.

20. The olefin polymer produced by the polymerization process of claim 15.

21. An article of manufacture comprising the olefin polymer of claim 20.
